(19) United States
(12) Patent Application Publication
(10) Pub. No.: US 2026/0332371 A1
(43) Pub. Date: Oct. 22, 2026

(54) COMMUNICATION DEVICE AND COMMUNICATION METHOD

(71) Applicant: Sony Group Corporation, Tokyo (JP)

(72) Inventors: Ren SUGAI, Tokyo (JP); Naoki KUSASHIMA, Tokyo (JP)

(73) Assignee: Sony Group Corporation, Tokyo (JP)

(21) Appl. No.: 19/107,583

(22) PCT Filed: Aug. 31, 2023
(86) PCT No.: PCT/JP2023/031851

§ 371 Date: Feb. 28, 2025

(30) Foreign Application Priority Data
Sep. 8, 2022 (JP) 2022-142955

(51) Int. Cl. H04L 5/14

(52) U.S. Cl. CPC H04L 5/14

(57) ABSTRACT

A communication device of the present disclosure includes a control unit. The control unit determines whether or not a digital interference canceller is applicable to a reception signal received in in-band full-duplex communication. In a case where it is determined that the digital interference canceller is not applicable, the control unit determines whether or not to apply the digital interference canceller to the reception signal. In a case where it is determined to apply the digital interference canceller, the control unit determines to perform processing for applying the digital interference canceller with another communication device with which the in-band full-duplex communication is performed.

### FIELD

The present disclosure relates to a communication device and a communication method.

### BACKGROUND

In order to improve frequency utilization efficiency in wireless communication devices, in-band full-duplex communication is under study. The in-band full-duplex communication is a scheme of performing full-duplex communication in the same band. The in-band full-duplex communication can double the frequency utilization efficiency as compared with full-duplex communication in which transmission and reception are performed in different bands.

In this in-band full-duplex communication, when a certain terminal transmits an uplink signal to a base station, a different terminal in the same cell can simultaneously receive a downlink signal from the base station. In this case, there is an issue of inter-terminal interference, which is interference between terminal devices in which the transmitted uplink signal interferes with the downlink signal of the other terminal. In order to prevent this inter-terminal interference, a communication device that measures inter-terminal interference before in-band full-duplex communication is performed is proposed (see, for example, Patent Literature 1).

### CITATION LIST

### Patent Literature

Patent Literature 1: WO 2019/142512 A

### SUMMARY

### Technical Problem

In the above-described technology, in-band full-duplex communication is performed with the uplink and the downlink in synchronization. However, in order to further improve the frequency utilization efficiency, it is desirable to perform asynchronous in-band full-duplex communication in the uplink and the downlink.

In asynchronous in-band full-duplex communication, it is necessary to wait until an end point of a frame in order to cancel interference, which may cause a delay.

Therefore, the present disclosure provides a mechanism capable of further reducing delay.

Note that the above disadvantage or object is merely one of a plurality of disadvantages or objects that can be solved or achieved by a plurality of embodiments disclosed herein.

### Solution to Problem

A communication device of the present disclosure includes a control unit. The control unit determines whether or not a digital interference canceller is applicable to a reception signal received in in-band full-duplex communication. In a case where it is determined that the digital interference canceller is not applicable, the control unit determines whether or not to apply the digital interference canceller to the reception signal. In a case where it is determined to apply the digital interference canceller, the control unit determines to perform processing for applying the digital interference canceller with another communication device with which the in-band full-duplex communication is performed.

### BRIEF DESCRIPTION OF DRAWINGS

FIG. 1 is a diagram illustrating a configuration example of a communication system according to an embodiment of the disclosure.

FIG. 2 is a diagram illustrating a configuration example of a management device according to the embodiment of the disclosure.

FIG. 3 is a diagram illustrating a configuration example of a base station according to the embodiment of the disclosure.

FIG. 4 is a diagram illustrating a configuration example of a relay station according to the embodiment of the disclosure.

FIG. 5 is a diagram illustrating a configuration example of a terminal device according to the embodiment of the disclosure.

FIG. 6 is a diagram illustrating an overview of in-band full-duplex communication.

FIG. 7 is a diagram illustrating an example of a communication method of eMBB and URLLC.

FIG. 8 is a diagram for explaining interference between terminal devices that occurs during an in-band full-duplex communication operation by a base station.

FIG. 9 is a diagram for explaining interference between terminal devices that occurs during an in-band full-duplex communication operation by a base station.

FIG. 10 is a diagram illustrating an example of asynchronous communication.

FIG. 11 is a diagram illustrating another example of asynchronous communication.

FIG. 12 is a diagram illustrating another example of asynchronous communication.

FIG. 13 is a diagram illustrating another example of asynchronous communication.

FIG. 14 is a diagram illustrating an example of first communication timing of asynchronous communication.

FIG. 15 is a diagram illustrating an example of second communication timing of asynchronous communication.

FIG. 16 is a diagram illustrating an example of third communication timing of asynchronous communication.

FIG. 17 is a diagram illustrating an example of fourth communication timing of asynchronous communication.

FIG. 18 is a flowchart illustrating an exemplary flow of execution determination processing of a digital interference canceller according to the embodiment of the present disclosure.

FIG. 19 is a flowchart illustrating an exemplary flow of execution determination processing of an analog interference canceller according to the embodiment of the present disclosure.

FIG. 20 is a sequence diagram illustrating an exemplary flow of execution determination according to the embodiment of the present disclosure.

FIG. 21 is a sequence diagram illustrating an exemplary flow of synchronization establishment processing according to the embodiment of the disclosure.

FIG. 22 is a sequence diagram illustrating another exemplary flow of the synchronization establishment processing according to the embodiment of the disclosure.

FIG. 23 is a sequence diagram illustrating an exemplary flow of first preprocessing according to the embodiment of the disclosure.

FIG. 24 is a diagram for describing an example of asynchronous transmission according to the embodiment of the present disclosure.

### DESCRIPTION OF EMBODIMENTS

Hereinafter, embodiments of the present disclosure will be described in detail by referring to the accompanying drawings. Note that, in the present specification and the drawings, components having substantially the same functional configuration are denoted by the same reference numerals, and redundant description is omitted.

Note that, in the present specification and the drawings, a plurality of components having substantially the same functional configuration may be distinguished by attaching different numerals after the same symbol. For example, a plurality of components having substantially the same functional configuration is distinguished in such a manner as terminal devices 40₁, 40₂, and 40₃, as necessary. However, in a case where it is not particularly necessary to distinguish each of a plurality of components having substantially the same functional configuration, only the same symbol is attached. For example, in a case where it is not necessary to particularly distinguish between the terminal devices 40_{1,} 40₂, and 40₃, they are simply referred to as the terminal devices 40.

One or a plurality of embodiments (including examples, modifications, and applications) described below can be each implemented independently. Meanwhile, at least a part of the plurality of embodiments described below may be combined with and implemented together with at least a part of another embodiment as appropriate. The plurality of embodiments may include novel features different from each other. Therefore, the plurality of embodiments can contribute to solving mutually different objects or disadvantages and achieve mutually different effects.

### <<1. Basic Configuration>>

<1.1. Configuration of Communication System>
<1.1.1. Overall Configuration of Communication System>

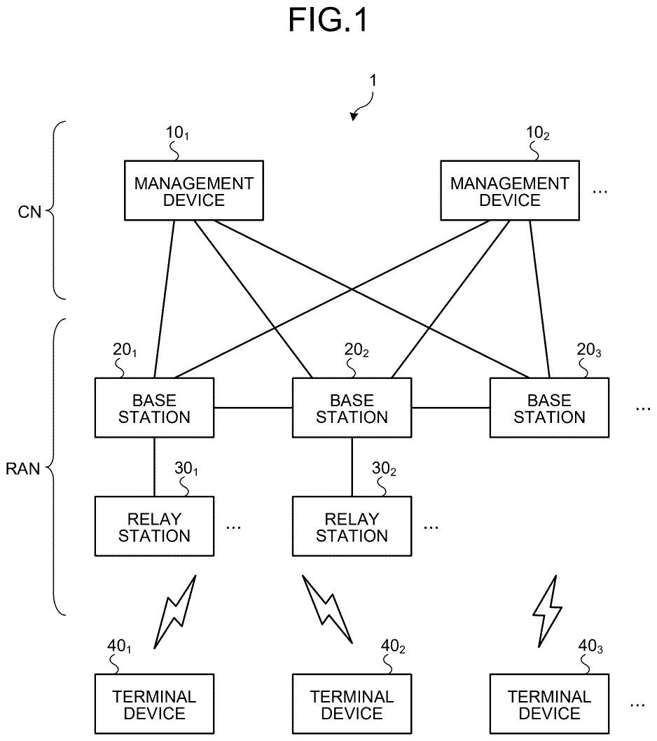

FIG. 1 is a diagram illustrating a configuration example of a communication system 1 according to an embodiment of the disclosure. The communication system 1 includes management devices 10, base stations 20, relay stations 30, and terminal devices 40. The communication system 1 provides a user with a wireless network that enables mobile communication with wireless communication devices included in the communication system 1 operating in cooperation. The wireless network of the present embodiment includes, for example, a radio access network and a core network. Note that, in the embodiment, the wireless communication devices refer to devices having a function of wireless communication and correspond to the base stations 20, the relay stations 30, and the terminal devices 40 in the example of FIG. 1. In the following description, a wireless communication device may be simply referred to as a communication device.

The communication system 1 may include a plurality of management devices 10, a plurality of base stations 20, a plurality of relay stations 30, or a plurality of terminal devices 40. In the example of FIG. 1, the communication system 1 includes management devices 10₁ and 10₂ and the like as the management devices 10 and includes base stations 20₁ and 20₂ and the like as the base stations 20. Furthermore, the communication system 1 includes relay stations 30₁ and 30₂ and the like as the relay stations 30 and includes terminal devices 40₁, 40₂, and 40₃ and the like as the terminal devices 40.

Note that the devices in the drawing may be regarded as devices in a logical sense. That is, some of the devices in the drawing may be implemented by a virtual machine (VM), a container, or the like, and they may be implemented on physically the same hardware.

Note that the communication system 1 may support a radio access technology (RAT) such as long term evolution (LTE) or new radio (NR). LTE and NR are types of cellular communication technology, which enable mobile communication of a terminal device 40 by arranging a plurality of areas covered by base stations 20 in the shape of cells.

Note that the radio access scheme used by the communication system 1 is not limited to LTE and NR and may be another radio access scheme such as wideband code division multiple access (W-CDMA) or code division multiple access 2000 (cdma2000).

Furthermore, the base stations 20 and the relay stations 30 included in the communication system 1 may be a ground station or a non-ground station. A non-ground station may be a satellite station or an aircraft station. If the non-ground station is a satellite station, the communication system 1 may be a bent-pipe (transparent)-type mobile satellite communication system.

Note that, in the present embodiment, a ground station (also referred to as a ground base station) refers to a base station 20 (including a relay station 30) installed on the ground. The “ground” refers to the ground in a broad sense including not only the land but also underground, on water, and underwater. Note that, in the following description, the description of “ground station” may be replaced with “gateway”.

Note that an LTE base station 20 may be referred to as an evolved node B (eNodeB) or an eNB. Meanwhile, an NR base station 20 may be referred to as a gNodeB or a gNB. In LTE and NR, a terminal device 40 (also referred to as a mobile station or a terminal) may be referred to as user equipment (UE). Note that a terminal device 40 is a type of communication device and is also referred to as a mobile station or a terminal.

In the present embodiment, the concept of the communication device includes not only a portable mobile device (terminal device) such as a mobile terminal but also a device installed in a structure or a traveling body. A structure or a traveling body itself may be regarded as a communication device. In addition, the concept of the communication device includes not only the terminal devices 40 but also the base stations 20 and the relay stations 30. A communication device is a type of processing devices and information processing devices. Furthermore, a communication device can be rephrased as a transmission device or a reception device.

Hereinafter, the configuration of each device included in the communication system 1 will be specifically described. Note that the configurations of the respective devices described below are merely examples. The configuration of each of the devices may be different from the following configuration.
<1.1.2. Configuration of Management Device>

Next, the configuration of a management device 10 will be described.

The management device 10 manages the wireless network. For example, the management device 10 manages communication of base stations 20. The management device 10 may have, for example, a function as a mobility management entity (MME). The management device 10 may have a function as an access and mobility management function (AMF) and/or a session management function (SMF). Of course, the functions of the management device 10 are not limited to the MME, the AMF, or the SMF. The management device 10 may have a function as a network slice selection function (NSSF), an authentication server function (AUSF), a policy control function (PCF), or unified data management (UDM). The management device 10 may further have a function as a home subscriber server (HSS).

Note that the management device 10 may have a function as a gateway. For example, the management device 10 may have a function as a serving gateway (S-GW) or a packet data network gateway (P-GW). Furthermore, the management device 10 may have a function as a user plane function (UPF).

The core network includes a plurality of network functions, and the network functions may be aggregated into one physical device or distributed to a plurality of physical devices. That is, the management device 10 can be dispersedly arranged in a plurality of devices. Furthermore, this distributed arrangement may be controlled to be performed dynamically. The base stations 20 and the management devices 10 constitute one network and provide wireless communication service to the terminal devices 40. The management device 10 is connected to the Internet, and a terminal device 40 can use various types of service provided via the Internet via a base station 20.

Note that the management device 10 is not necessarily included in the core network. For example, let us presume that the core network is wideband code division multiple access (W-CDMA) or code division multiple access 2000 (cdma2000). In this case, the management device 10 may function as a radio network controller (RNC).

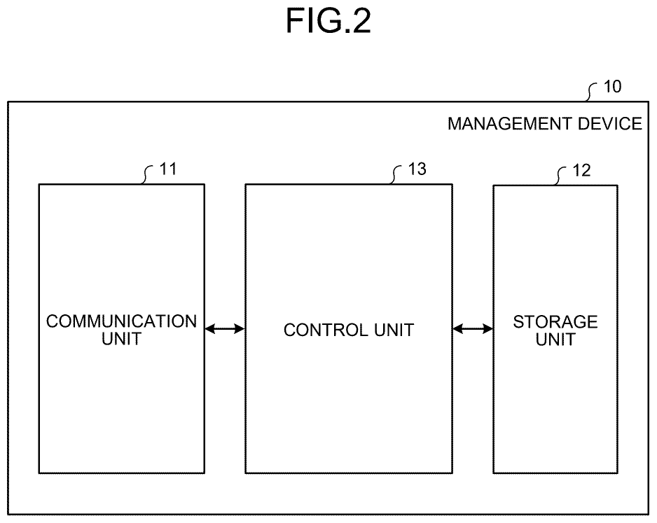

FIG. 2 is a diagram illustrating a configuration example of a management device 10 according to the embodiment of the disclosure. The management device 10 includes a communication unit 11, a storage unit 12, and a control unit 13. Note that the configuration illustrated in FIG. 2 is a functional configuration, and the hardware configuration may be different from the configuration in the drawing. Furthermore, the functions of the management device 10 may be implemented in a statically or dynamically distributed manner in a plurality of physically separated configurations. For example, the management device 10 may include a plurality of server devices.

The communication unit 11 is a communication interface for communicating with other devices. The communication unit 11 may be a network interface or a device connection interface. For example, the communication unit 11 may be a local area network (LAN) interface such as a network interface card (NIC) or may be a Universal Serial Bus (USB) interface including a USB host controller, a USB port, and the like. The communication unit 11 may be a wired interface or a wireless interface. The communication unit 11 functions as a communication means of the management device 10. The communication unit 11 communicates with a base station 20 or others under the control by the control unit 13.

The storage unit 12 is a storage device capable of reading and writing data, such as a dynamic random access memory (DRAM), a static random access memory (SRAM), a flash memory, or a hard disk. The storage unit 12 functions as a storage means of the management device 10. The storage unit 12 stores, for example, the connection state of a terminal device 40. For example, the storage unit 12 stores the state of radio resource control (RRC) or the state of EPS connection management (ECM) or the state of 5G system connection management (CM) of the terminal device 40. The storage unit 12 may function as a home memory that stores position information of a terminal device 40.

The control unit 13 is a controller that controls each of the units of the management device 10. The control unit 13 is implemented by, for example, a processor such as a central processing unit (CPU), a micro processing unit (MPU), or a graphics processing unit (GPU). For example, the control unit 13 is implemented by a processor executing various programs stored in a storage device inside the management device 10 using a random access memory (RAM) or the like as a work area. Note that the control unit 13 may be implemented by an integrated circuit such as an application specific integrated circuit (ASIC) or a field programmable gate array (FPGA). Any of the CPU, the MPU, the GPU, the ASIC, and the FPGA can be regarded as a controller.
<1.1.3. Configuration of Base Station>

A base station 20 is a communication device that operates a cell and provides wireless communication services to one or more terminal devices 40 located inside the coverage of the cell. The cell is operated in accordance with a desired wireless communication scheme such as LTE or NR. The base station 20 is connected to the core network. The core network is connected to a packet data network via a gateway device.

Note that the base station 20 may include a set of a plurality of physical or logical devices. For example, in the embodiment of the disclosure, the base station 20 may be distinguished into a plurality of devices of baseband units (BBUs) and radio units (RUs) and may be interpreted as aggregate of the plurality of devices. Furthermore or alternatively, in the embodiment of the disclosure, the base station 20 may be either one of or both a BBU and an RU. The BBU and the RU may be connected by a predetermined interface (for example, eCPRI). Furthermore or alternatively, the RU may be referred to as a remote radio unit (RRU) or a Radio DoT (RD). Furthermore or alternatively, the RU may correspond to a gNB-DU described later. Furthermore or alternatively, the BBU may correspond to a gNB-CU described later. Alternatively, the RU may be connected to a gNB-DU described later. Furthermore, the BBU may correspond to a combination of a gNB-CU and a gNB-DU to be described later. Furthermore or alternatively, the RU may be a device integrally formed with an antenna. An antenna (for example, an antenna integrally formed with an RU) included in the base station 20 may adopt advanced antenna systems and support MIMO (for example, FD-MIMO) or beamforming. In the advanced antenna systems, an antenna (for example, an antenna integrally formed with the RU) included in the base station 20 may include, for example, 64 transmission antenna ports and 64 reception antenna ports.

Furthermore, a plurality of base stations 20 may be connected to each other. One or more base stations 20 may be included in a radio access network (RAN). That is, the base station 20 may be simply referred to as a RAN, a RAN node, an access network (AN), or an AN node. A RAN in LTE is referred to as an enhanced universal terrestrial RAN (EUTRAN). A RAN in NR is referred to as an NGRAN. A RAN in W-CDMA (UMTS) is referred to as a UTRAN. The base station 20 in LTE is referred to as an evolved node B (eNodeB) or an eNB. That is, the EUTRAN includes one or more eNodeBs (eNBs). Meanwhile, a base station 20 of NR is referred to as a gNodeB or a gNB. That is, the NGRAN includes one or more gNBs. Furthermore, the EUTRAN may include a gNB (en-gNB) connected to a core network (EPC) in an LTE communication system (EPS). Similarly, the NGRAN may include an ng-eNB connected to a core network 5GC in a 5G communications system (5GS). Furthermore or alternatively, in a case where the base station 20 is an eNB, a gNB, or the like, it may be referred to as 3GPP Access. Furthermore or alternatively, in a case where the base station 20 is a wireless access point (e.g. access point of WiFi (registered trademark)), it may be referred to as Non-3GPP access. Furthermore or alternatively, the base station 20 may be an optical extension device called a remote radio head (RRH). Furthermore or alternatively, in a case where the base station 20 is a gNB, the base station 20 may be referred to as a combination of the above-described gNB central unit (CU) and gNB distributed unit (DU) or any one of them. The gNB central unit (CU) hosts a plurality of upper layers (for example, RRC, SDAP, or PDCP) in the access stratum for communication with UE. Meanwhile, the gNB-DU hosts a plurality of lower layers (for example, RLC, MAC, or PHY) in the access stratum. That is, among messages and information described later, RRC signalling (for example, various SIBs including MIB and SIB1, an RRCSetup message, and an RRCReconfiguration message) may be generated by the gNB-CU, whereas a DCI or various physical channels (for example, PDCCH or PBCH) described later may be generated by the gNB-DU. Alternatively, in the RRC signalling, for example, some configurations (setting information) such as IE: cellGroupConfig may be generated by the gNB-DU, and the remaining configurations may be generated by the gNB-CU. These configurations (setting information) may be transmitted and received by an F1 interface described later. The base station 20 may be configured to be capable of communicating with another base station 20. For example, in a case where the plurality of base stations 20 is eNBs or a combination of eNBs and en-gNBs, the base stations 20 may be connected by an X2 interface. Furthermore or alternatively, in a case where the plurality of base stations 20 is gNBs or a combination of gn-eNBs and gNBs, the devices may be connected by an Xn interface. Furthermore or alternatively, in a case where the plurality of base stations 20 is a combination of gNB central units (CUs) and gNB distributed units (DUs), the devices may be connected by the above-described F1 interface. Messages and information (information of RRC signalling or the DCI, physical channel) described later may be communicated among a plurality of base stations 20 (e.g. via the X2, Xn, or F1 interface).

Furthermore, as described above, the base station 20 may be configured to manage a plurality of cells. A cell provided by a base station 20 is referred to as a serving cell. Serving cells include a primary cell (PCell) and a secondary cell (SCell). In a case where dual connectivity (for example, EUTRA-EUTRA dual connectivity, EUTRA-NR dual connectivity (ENDC), EUTRA-NR dual connectivity with 5GC, NR-EUTRA dual connectivity (NEDC), or NR-NR dual connectivity) is provided to UE (for example, terminal devices 40), a PCell and zero or one or more SCell(s) provided by a master node (MN) are referred to as a master cell group. The serving cells may also include a PSCell (primary secondary cell or primary SCG cell). That is, in a case where dual connectivity is provided to UE, a PSCell and zero or one or more SCell(s) provided by a secondary node (SN) are referred to as a secondary cell group (SCG). Unless specially configured (for example, PUCCH on SCell), the transmission in the physical uplink control channel (PUCCH) is performed in the PCell and the PSCell but not in the SCells. In addition, a radio link failure is detected in the PCell and the PSCell but not in the SCells (not required to be detected). As described above, since the PCell and the PSCell have a special role among the serving cells, they are also referred to as special cells (SpCells). One downlink component carrier and one uplink component carrier may be associated with one cell. In addition, a system bandwidth corresponding to one cell may be divided into a plurality of bandwidth parts. In this case, one or more bandwidth parts (BWPs) may be configured for UE, and one bandwidth part may be used for the UE as an active BWP. Furthermore, radio resources (for example, a frequency band, numerology (subcarrier spacing), and a slot format (slot configuration)) that a terminal device 40 can use may be different from cell to cell, component carrier to component carrier, or BWP to BWP.

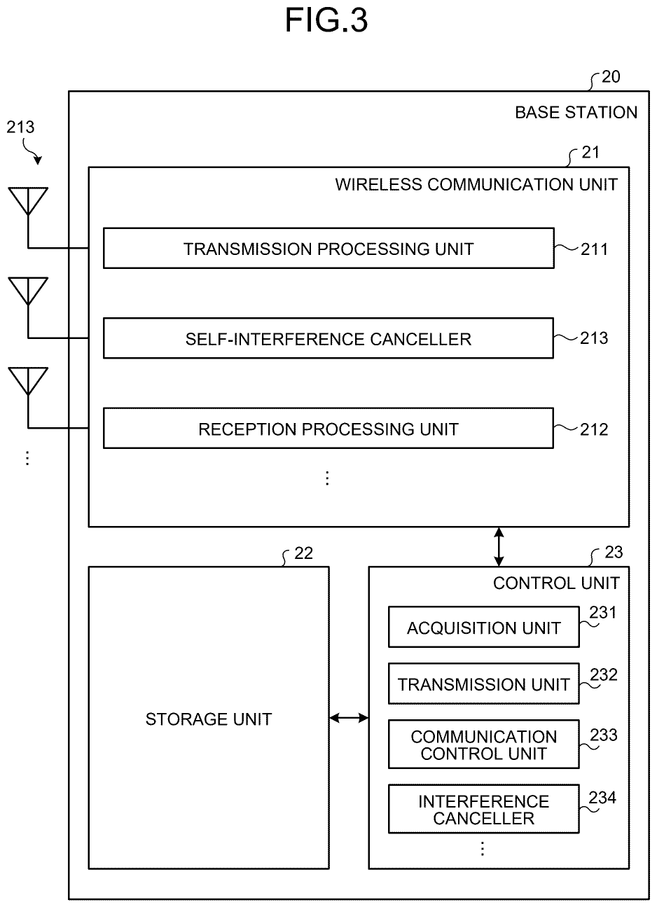

FIG. 3 is a diagram illustrating a configuration example of a base station 20 according to the embodiment of the disclosure. The base station 20 includes a wireless communication unit 21, a storage unit 22, and a control unit 23. Note that the configuration illustrated in FIG. 3 is a functional configuration, and the hardware configuration may be different from this. Furthermore, the functions of the base station 20 may be implemented in a distributed manner in a plurality of physically separated configurations.

The wireless communication unit 21 is a signal processing unit for wirelessly communicating with another wireless communication device (for example, a terminal device 40). The wireless communication unit 21 operates under the control by the control unit 23. The wireless communication unit 21 supports one or a plurality of radio access schemes. For example, the wireless communication unit 21 supports both NR and LTE. The wireless communication unit 21 may support W-CDMA or cdma2000 in addition to NR or LTE. Furthermore, the wireless communication unit 21 may support automatic retransmission technology such as hybrid automatic repeat request (HARQ).

The wireless communication unit 21 includes a transmission processing unit 211, a reception processing unit 212, antennas 213, and a self-interference canceller 214. The wireless communication unit 21 may include a plurality of transmission processing units 211, a plurality of reception processing units 212, and a plurality of antennas 213. Note that, in a case where the wireless communication unit 21 supports a plurality of radio access schemes, the units of the wireless communication unit 21 can be individually configured for each of the radio access schemes. For example, a pair of the transmission processing unit 211 and the reception processing unit 212 may be configured for LTE and NR separately. Furthermore, an antenna 213 may include a plurality of antenna elements (for example, a plurality of patch antennas). In this case, the wireless communication unit 21 may be configured to be capable of performing beamforming. The wireless communication unit 21 may be configured to be capable of performing polarization beamforming using a vertically polarized wave (V-polarized wave) and a horizontally polarized wave (H-polarized wave).

The transmission processing unit 211 performs transmission processing of downlink control information and downlink data. For example, the transmission processing unit 211 encodes downlink control information and downlink data input from the control unit 23 using an encoding scheme such as block encoding, convolutional encoding, or turbo encoding. At this point, for encoding, encoding with polar codes or encoding with low density parity check codes (LDPC codes) may be performed. Then, the transmission processing unit 211 modulates coded bits by a predetermined modulation scheme such as BPSK, QPSK, 16QAM, 64QAM, or 256QAM. In this case, signal points in a constellation are not necessarily equidistant. The constellation may be a non-uniform constellation (NUC). The transmission processing unit 211 multiplexes a modulation symbol and a downlink reference signal of each channel and allocates the multiplexed signal in a predetermined resource element. Then, the transmission processing unit 211 performs various types of signal processing on the multiplexed signal. For example, the transmission processing unit 211 performs processing such as transformation to a frequency domain by fast Fourier transform, addition of a guard interval (cyclic prefix), generation of a baseband digital signal, conversion to an analog signal, quadrature modulation, up-conversion, removal of an extra frequency component, or power amplification. The signal generated by the transmission processing unit 211 is transmitted from an antenna 213.

The reception processing unit 212 processes an uplink signal received via an antenna 213. For example, the reception processing unit 212 performs, on the uplink signal, down-conversion, removal of unnecessary frequency components, control of the amplification level, quadrature demodulation, conversion to a digital signal, removal of a guard interval (cyclic prefix), extraction of a frequency domain signal by fast Fourier transform, or others. Then, the reception processing unit 212 demultiplexes an uplink channel such as a physical uplink shared channel (PUSCH) or a physical uplink control channel (PUCCH) and an uplink reference signal from the signal having been subjected to these types of processing. The reception processing unit 212 also demodulates the reception signal using a modulation scheme such as binary phase shift keying (BPSK) or quadrature phase shift keying (QPSK) on a modulation symbol of the uplink channel. The modulation scheme used for the demodulation may be 16 quadrature amplitude modulation (QAM), 64QAM, or 256QAM. In this case, the signal points in the constellation are not necessarily equidistant. The constellation may be a non-uniform constellation (NUC). The, the reception processing unit 212 performs decoding processing on the encoded bits of the demodulated uplink channel. The decoded uplink data and uplink control information are output to the control unit 23.

An antenna 213 is an antenna device (antenna unit) that mutually converts a current and a radio wave. The antenna 213 may include one antenna element (for example, one patch antenna) or may include a plurality of antenna elements (for example, a plurality of patch antennas). In a case where the antenna 213 includes a plurality of antenna elements, the wireless communication unit 21 may be configured to be capable of performing beamforming. For example, the wireless communication unit 21 may be configured to generate a directional beam by controlling the directivity of a wireless signal using a plurality of antenna elements. Note that the antenna 213 may be a dual-polarized antenna. In a case where the antenna 213 is a dual-polarized antenna, the wireless communication unit 21 may use a vertically polarized wave (V-polarized wave) and a horizontally polarized wave (H-polarized wave) for transmitting wireless signals. The wireless communication unit 21 may further control the directivity of the wireless signals transmitted using the vertically polarized wave and the horizontally polarized wave. Furthermore, the wireless communication unit 21 may transmit and receive spatially multiplexed signals via a plurality of layers including a plurality of antenna elements.

The self-interference canceller 214 cancels self-interference in which a signal transmitted by the transmission processing unit 211 leaks into the reception processing unit 212.

The storage unit 22 is a storage device capable of reading and writing data, such as a DRAM, an SRAM, a flash memory, or a hard disk. The storage unit 22 functions as a storage means of the base station 20.

The control unit 23 is a controller that controls each of the units of the base station 20. The control unit 23 is implemented by, for example, a processor such as a central processing unit (CPU) or a micro processing unit (MPU). For example, the control unit 23 is implemented by the processor executing various programs stored in a storage device inside the base station 20 while using a random access memory (RAM) or the like as a work area. Note that the control unit 23 may be implemented by an integrated circuit such as an application specific integrated circuit (ASIC) or a field programmable gate array (FPGA). Any of the CPU, the MPU, the ASIC, and the FPGA can be regarded as a controller. Furthermore, the control unit 23 may be implemented by a graphics processing unit (GPU) in addition to or instead of the CPU.

As illustrated in FIG. 3, the control unit 23 includes an acquisition unit 231, a transmission unit 232, a communication control unit 233, and an interference canceller 234. Each of the blocks (acquisition unit 231 to interference canceller 234) included in the control unit 23 is a functional block indicating a function of the control unit 23. These functional blocks may be software blocks or hardware blocks. For example, each of the functional blocks described above may be one software module implemented by software (including microprograms) or may be one circuit block on a semiconductor chip (die). It is naturally understood that each of the functional blocks may be one processor or one integrated circuit. The functional blocks may be configured in any manner. Note that the control unit 23 may include functional units different from the above-described functional blocks. The operation of the control unit 23 may be the same as the operation of each block of a control unit 43 of a terminal device 40.
<1.1.4. Configuration of Relay Station>

A relay station 30 is a device serving as a relay station of a base station 20. The relay station 30 is a type of base station 20. The relay station 30 is also a type of information processing device. The relay station 30 can be rephrased as a relay base station. Furthermore, the relay station 30 may be a device called a repeater (e. g. RF repeater, smart repeater, and intelligent surface).

The relay station 30 can perform wireless communication such as NOMA communication with a terminal device 40. The relay station 30 relays communication between a base station 20 and a terminal device 40. Note that the relay station 30 may be configured to be able to wirelessly communicate with another relay station 30 or base station 20. The relay station 30 may be a ground station device or a non-ground station device. The relay station 30 are included in a radio access network RAN together with a base station 20.

Note that the relay station 30 of the present embodiment may be a fixed device, a movable device, or a floating device. In addition, the size of the coverage of the relay station 30 of the present embodiment is not limited to a specific size. For example, the cell covered by the relay station 30 may be a macro cell, a micro cell, or a small cell.

In addition, the relay station 30 of the present embodiment is not limited to a mounted device as long as the function of relay is satisfied. For example, the relay station 30 may be mounted on a terminal device 40 such as a smartphone, may be mounted on an automobile, a train, or a ricksha, may be mounted on a balloon, an airplane, or a drone, may be mounted on a traffic light, a sign, a street light, or the like, or may be mounted on a home appliance such as a television, a game machine, an air conditioner, a refrigerator, or a lighting fixture.

Other configuration of the relay station 30 may be similar to the configuration of the base station 20 described above. For example, similarly to the base station 20 described above, the relay station 30 may be a device installed in a mobile body or may be a mobile body itself. As described above, the mobile body may be a mobile terminal such as a smartphone or a mobile phone. In addition, the mobile body may be a traveling body that travels on the land (on the ground in a narrow sense) or may be a traveling body that travels underground. It goes without saying that the mobile body may be a traveling body that travels on water or may be a traveling body that travels under water. In addition, the mobile body may be a traveling body that travels within the atmosphere or may be a traveling body that travels outside the atmosphere. Meanwhile, the relay station 30 may be a ground station device or a non-ground station device. In this case, the relay station 30 may be an aircraft station or a satellite station.

Furthermore, the size of the coverage of the relay station 30 may be large such as a macro cell or small such as a pico cell, similarly to the base station 20. It goes without saying that the size of the coverage of the relay station 30 may be extremely small such as a femtocell. Furthermore, the relay station 30 may have a beamforming capability. In this case, in the relay station 30, a cell or a service area may be formed for each beam.

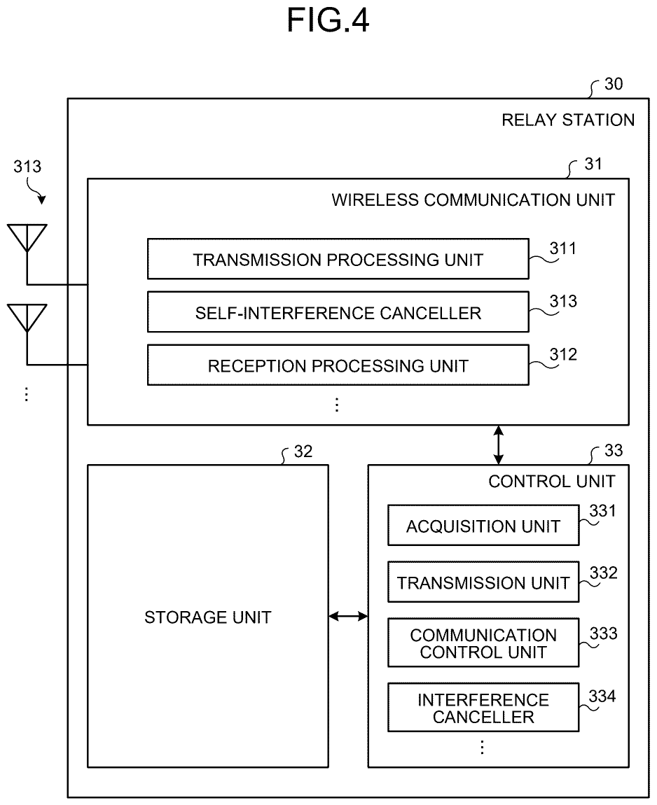

FIG. 4 is a diagram illustrating a configuration example of a relay station 30 according to the embodiment of the disclosure. The relay station 30 includes a wireless communication unit 31, a storage unit 32, and a control unit 33. Note that the configuration illustrated in FIG. 4 is a functional configuration, and the hardware configuration may be different from the functional configuration. Furthermore, the functions of the relay station 30 may be implemented in a distributed manner in a plurality of physically separated configurations.

The wireless communication unit 31 is a wireless communication interface that wirelessly communicates with other wireless communication devices (for example, a base station 20, a terminal device 40, and another relay station 30). The wireless communication unit 31 supports one or a plurality of radio access schemes. For example, the wireless communication unit 31 supports both NR and LTE. The wireless communication unit 31 may also support W-CDMA or cdma2000 in addition to NR or LTE.

The wireless communication unit 31 includes a transmission processing unit 311, a reception processing unit 312, antennas 313, and a self-interference canceller 314. The wireless communication unit 31 may include a plurality of transmission processing units 311, a plurality of reception processing units 312, and a plurality of antennas 313. Note that, in a case where the wireless communication unit 31 supports a plurality of radio access schemes, the units of the wireless communication unit 31 can be individually configured for each of the radio access schemes. For example, a pair of the transmission processing unit 311 and the reception processing unit 312 may be configured for LTE and NR separately. The configurations of the transmission processing unit 311, the reception processing unit 312, the antennas 313, and the self-interference canceller 314 are similar to the configurations of the transmission processing unit 211, the reception processing unit 212, and the antennas 213 described above. Note that the wireless communication unit 31 may be configured to be capable of performing beamforming similarly to the wireless communication unit 21.

The storage unit 32 is a storage device capable of reading and writing data, such as a DRAM, an SRAM, a flash memory, or a hard disk. The storage unit 32 functions as a storage means of the relay station 30.

The control unit 33 is a controller that controls each of the units of the relay station 30. The control unit 33 is implemented by, for example, a processor such as a CPU, an MPU, or a GPU. For example, the control unit 33 is implemented by the processor executing various programs stored in the storage device inside the relay station 30 using a RAM or the like as a work area. Note that the control unit 33 may be implemented by an integrated circuit such as an ASIC or an FPGA. Any of the CPU, the MPU, the GPU, the ASIC, and the FPGA can be regarded as a controller. The operation of the control unit 33 may be the same as the operation of the control unit 23 of the base station 20.

As illustrated in FIG. 4, the control unit 33 includes an acquisition unit 331, a transmission unit 332, a communication control unit 333, and an interference canceller 334. Each of the blocks (acquisition unit 331 to interference canceller 234) included in the control unit 33 is a functional block indicating a function of the control unit 33. These functional blocks may be software blocks or hardware blocks. For example, each of the functional blocks described above may be one software module implemented by software (including microprograms) or may be one circuit block on a semiconductor chip (die). It is naturally understood that each of the functional blocks may be one processor or one integrated circuit. The functional blocks may be configured in any manner. Note that the control unit 33 may include functional units different from the above-described functional blocks. The operation of the control unit 33 may be the same as the operation of each block of the control unit 23 of the base station 20.

Note that the relay station 30 may be an IAB relay node. The relay station 30 operates as an IAB mobile termination (IAB-MT) for an IAB donor node that provides backhaul and operates as an IAB distributed unit (IAB-DU) for a terminal device 40 that provides access. The IAB donor node may be, for example, a base station 20, and operates as an IAB central unit (IAB-CU).
<1.1.5. Configuration of Terminal Device>

A terminal device 40 is a wireless communication device that wirelessly communicates with other communication devices such as a base station 20 and a relay station 30. The terminal device 40 is, for example, a mobile phone, a smart device (smartphone or tablet), a personal digital assistant (PDA), or a personal computer. Furthermore, the terminal device 40 may be a device such as a business camera provided with a communication function or may be a motorcycle or a mobile relay vehicle on which a communication device such as a field pickup unit (FPU) is mounted. Alternatively, the terminal device 40 may be a machine to machine (M2M) device or an Internet of things (IoT) device.

Note that the terminal device 40 may be capable of performing NOMA communication with a base station 20. Furthermore, the terminal device 40 may be able to use automatic retransmission technology such as HARQ when communicating with a base station 20. Furthermore, the terminal device 40 may be capable of performing sidelink communication with another terminal device 40. The terminal device 40 may also be able to use automatic retransmission technology such as HARQ when performing sidelink communication. Note that the terminal device 40 may also be capable of performing NOMA communication in communication (sidelink) with another terminal device 40. Furthermore, the terminal device 40 may be capable of performing LPWA communication with another communication device (for example, a base station 20 and another terminal device 40). In addition, the wireless communication used by the terminal device 40 may be wireless communication using millimeter waves. Note that the wireless communication (including sidelink communication) used by the terminal device 40 may be wireless communication using radio waves or wireless communication using infrared rays or visible light (optical radio).

Furthermore, the terminal device 40 may be a mobile device. The mobile device is a wireless communication device that is mobile. In this case, the terminal device 40 may be a wireless communication device installed in a traveling body or may be a traveling body itself. For example, the terminal device 40 may be a vehicle that travels on a road such as an automobile, a bus, a truck, or a motorcycle, a vehicle that travels on a rail installed on a track such as a train, or a wireless communication device mounted on the vehicle. Note that the mobile body may be a mobile terminal or may be a traveling body that travels on the land (on the ground in a narrow sense), underground, on water, or under water. Furthermore, the mobile body may be a traveling body that travels within the atmosphere, such as a drone or a helicopter or may be a traveling body that travels outside the atmosphere, such as an artificial satellite.

The terminal device 40 may be simultaneously connected to a plurality of base stations 20 or a plurality of cells to perform communication. For example, in a case where one base station 20 supports a communication area via a plurality of cells (for example, pCell and sCells), it is possible to bundle the plurality of cells to enable communication between the base station 20 and the terminal device 40 by carrier aggregation (CA) technology, dual connectivity (DC) technology, or multi-connectivity (MC) technology. Alternatively, the terminal device 40 and the plurality of base stations 20 can communicate with each other by coordinated multi-point transmission and reception (CoMP) technology via cells of different base stations 20.

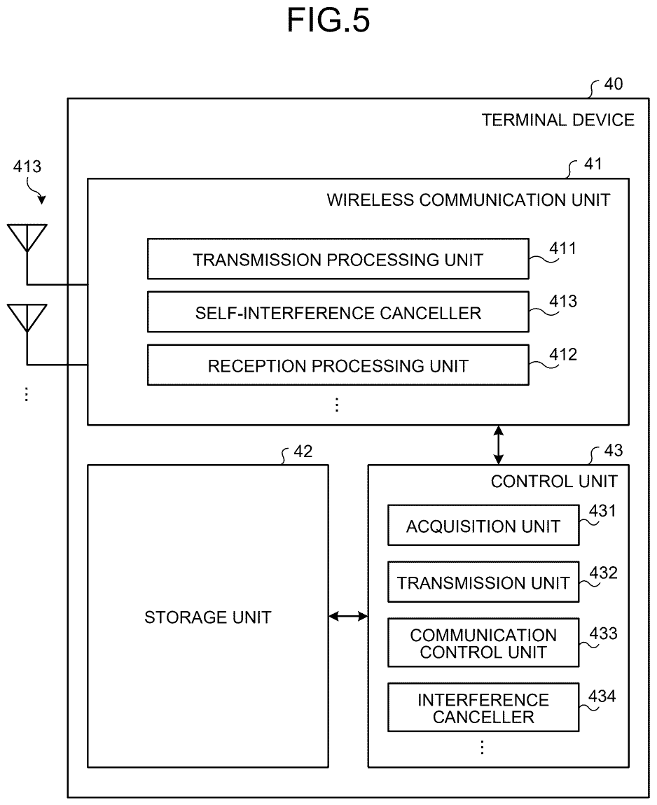

FIG. 5 is a diagram illustrating a configuration example of a terminal device 40 according to the embodiment of the disclosure. The terminal device 40 includes a wireless communication unit 41, a storage unit 42, and a control unit 43. Note that the configuration illustrated in FIG. 5 is a functional configuration, and the hardware configuration may be different from the functional configuration. Furthermore, the functions of the terminal device 40 may be implemented in a distributed manner to a plurality of physically separated configurations.

The wireless communication unit 41 is a signal processing unit for wirelessly communicating with another wireless communication device (for example, a base station 20, a relay station 30, or another terminal device 40). The wireless communication unit 41 operates under the control by the control unit 43. The wireless communication unit 41 includes a transmission processing unit 411, a reception processing unit 412, antennas 413, and a self-interference canceller 414. The configurations of the wireless communication unit 41, the transmission processing unit 411, the reception processing unit 412, and the antennas 413 may be similar to those of the wireless communication unit 21, the transmission processing unit 211, the reception processing unit 212, and the antennas 213 of the base station 20. Note that the wireless communication unit 41 may be configured to be capable of performing beamforming similarly to the wireless communication unit 21. Furthermore, similarly to the wireless communication unit 21, the wireless communication unit 41 may be configured to be capable of transmitting and receiving spatially multiplexed signals.

The storage unit 42 is a storage device capable of reading and writing data, such as a DRAM, an SRAM, a flash memory, or a hard disk. The storage unit 42 functions as a storage means of the terminal device 40.

The control unit 43 is a controller that controls each of the units of the terminal device 40. The control unit 43 is implemented by a processor such as a CPU or an MPU. For example, the control unit 43 is implemented by the processor executing various programs stored in the storage device inside the terminal device 40 using a RAM or the like as a work area. Note that the control unit 43 may be implemented by an integrated circuit such as an ASIC or an FPGA. Any of the CPU, the MPU, the ASIC, and the FPGA can be regarded as a controller. Furthermore, the control unit 43 may be implemented by a GPU in addition to or instead of the CPU.

As illustrated in FIG. 5, the control unit 43 includes an acquisition unit 431, a transmission unit 432, a communication control unit 433, and an interference canceller 434. Each of the blocks (acquisition unit 431 to interference canceller 434) included in the control unit 43 is a functional block indicating a function of the control unit 43. These functional blocks may be software blocks or hardware blocks. For example, each of the functional blocks described above may be one software module implemented by software (including microprograms) or may be one circuit block on a semiconductor chip (die). It is naturally understood that each of the functional blocks may be one processor or one integrated circuit. The control unit 43 may include functional units different from the above-described functional blocks. The functional blocks may be configured in any manner. The operation of the control unit 43 may be the same as the operation of each block of the control unit 23 of the base station 20.

### <<2. Related Art>>

<2.1. Measurement of Interference State>

As described later, the communication system 1 performs in-band full-duplex communication. Therefore, interference occurs in link communication. Measurement of the interference state will be described.

### [Measurement of Channel]

In the present embodiment, a terminal device 40 and a base station 20 measure the state of a propagation route. The terminal device 40 and the base station 20 measure received power of a predetermined signal or received power of all signals by using set resources. The received power of the predetermined signal is also referred to as reference signal received power (RSRP). Meanwhile, the received power of all signals is also referred to as a received signal strength indicator (RSSI).

In 3GPP (registered trademark), examples of types of channel measurement include channel state information (CSI) measurement and radio resource management (RRM) measurement. The CSI measurement is also referred to as Layer 1 (L1) measurement, and the RRM measurement is also referred to as Layer 3 (L3) measurement.

### [CSI Measurement]

The result of the CSI measurement is mainly used for dynamic resource allocation such as dynamic scheduling.

The signal strength in the downlink CSI measurement is measured by using, for example, a CSI-RS. The downlink CSI measurement is reported, as CSI feedback, to the base station 20. The downlink CSI includes at least one of the followings.
Channel quality indicator (CQI)
Precoding matrix indicator (PMI)
CSI-RS resource indicator (CRI)
SS/PBCH block resource indicator (SSBRI)
Layer indicator (LI)
Rank indicator (RI)
L1-RSRP

The CQI is information indicating the channel quality with a serving cell. The terminal device 40 calculates the SINR satisfying a predetermined error rate of a physical downlink shared channel (PDSCH) as a CQI index and feeds back the SINR to the base station 20. The predetermined error rate is, for example, 10⁻¹ for eMBB and 10⁻⁵ for URLLC.

The PMI is information indicating a precoding matrix desired by the terminal device 40. The terminal device 40 calculates a precoding matrix appropriate for reception in the PDSCH and feeds back the precoding matrix to the base station 20 as the PMI.

The CRI is information indicating a CSI-RS with good reception quality. The terminal device 40 detects a CSI-RS with high CSI-RSRP and feeds back a CRI corresponding to the CSI-RS to the base station 20.

The SSBRI is information indicating an SS/PBCH block with good reception quality. The terminal device 40 detects an SS/PBCH block with high SS-RSRP and feeds back an SSBRI corresponding to the SS/PBCH block to the base station 20.

The LI is information indicating the strongest layer among the plurality of layers. The terminal device 40 calculates a layer with the high reception strength and feeds back the layer as the LI to the base station 20.

The RI is information indicating the place in ranking desired by the terminal device 40. The terminal device 40 calculates an appropriate place in ranking depending on the number of antennas and the reception quality and feeds back place in ranking to the base station 20.

L1-RSRP is information of RSRP in layer 1 (physical layer). L1-RSRP has a feature that a measurement and reporting cycle is shorter than those of RSRP in RRM measurement described later.

In downlink CSI measurement, a resource for performing channel measurement and a resource for performing interference measurement are defined in a set (CSI Resource Setting). The resource for performing channel measurement is defined by an NZP CSI-RS resource. The resource for performing interference measurement is defined by a CSI-IM resource or an NZP CSI-RS.

The base station 20 sets one or more types of CSI resource settings for the terminal device 40. The terminal device 40 measures desired signal power and interference power on the basis of the set CSI resource settings and calculates channel quality (such as SINR or CQI).

The signal strength in the uplink CSI measurement is measured using, for example, a sounding reference signal (SRS). There are three types of SRS transmission methods: periodic SRS transmission; semi-persistent SRS transmission; and aperiodic SRS transmission.

In the periodic SRS transmission, in a case where an SRS resource is set by the RRC, the terminal device 40 transmits the SRS using the set SRS resource.

In the semi-persistent SRS transmission, let us postulate that an SRS resource is set by the RRC and that the terminal device 40 has received an instruction of activation for the SRS transmission by the DCI. In this case, the terminal device 40 transmits the SRS using the set SRS resource until receiving an instruction of deactivation.

In the aperiodic SRS transmission, in a chase where the SRS resource is set by the RRC and that the SRS transmission trigger is instructed by the DCI, the terminal device 40 transmits the SRS once by the set SRS resource.

The time and frequency resources with which the SRS is transmitted are set by the RRC. The SRS is transmitted in six symbols in the tail of a slot. In the periodic SRS transmission and the semi-persistent SRS transmission, a period and a slot offset are set for the SRS.

### [RRM Measurement]

The result of the RRM measurement is mainly used for semi-static resource control such as RRC configuration or handover processing. In the RRM measurement, for example, reference signal received power (RSRP), reference signal received quality (RSRQ), received signal strength indicator (RSSI), signal to interference plus noise power ratio (SINR), and the like are measured.

RSRP (also referred to as L3-RSRP) in the RRM measurement is performed using, for example, an SS/PBCH block or a CSI-RS. The RSRP in the RRM measurement is calculated from one or more L1-RSRPs. For example, the RSRP in the RRM measurement is calculated as an average value of a plurality of pieces of L1-RSRP having different measurement resources.

The RSSI is total received power including interference and noise in a predetermined resource. The predetermined resource may be set by the base station 20.

The RSRQ is defined by RSRP×the number of resource blocks of the RSSI measurement bandwidth/RSSI.

The SINR is defined by a ratio of signal received power and interference noise power in a predetermined resource.

### [Cross-Link Interference]

It is based on the premise that, with the same time and frequency resources, a predetermined terminal device 40 (first terminal device 40₁) performs uplink transmission and that another terminal device 40 (second terminal device 40₂) simultaneously performs downlink reception. In this case, inter-terminal interference that gives interference to downlink reception may occur due to the uplink transmission signal.

In addition, it is based on the premise that a predetermined base station 20 (first base station 20₁) performs downlink transmission and that an adjacent base station 20 (second base station 20₂) simultaneously performs uplink reception with the same time and frequency resources. In this case, inter-base station interference (inter-cell interference) that gives interference to uplink reception may occur due to the downlink transmission signal.

These types of interference are also referred to as cross-link interference (CLI). For example, the base station 20 reduces the influence of cross-link interference by performing scheduling in consideration of cross-link interference.

### [Inter-Terminal Interference Measurement]

In 3GPP (registered trademark), inter-terminal interference (CLI) is measured and reported as the RRM. A CLI is measured by sounding reference signal-reference signal received power (SRS-RSRP) or cross-link interference-received signal strength indicator (CLI-RSSI).

The SRS-RSRP is received power of the SRS. Specifically, the SRS-RSRP is defined by a linear average of the power of resource elements on which the SRS is carried. An SRS resource is set for a terminal device 40. The terminal device 40 measures the received power of the SRS in the set SRS resource.

The CLI-RSSI is an RSSI for CLI measurement. Specifically, the CLI-RSSI is defined by a linear average of the total received power on a set OFDM symbol having a set measurement bandwidth.

An OFDM symbol for measuring the CLI-RSSI is set for the terminal device 40. Specifically, measurement subcarrier spacing, the measurement bandwidth (starting PRB and the number of PRBs), and measurement timing (period, time offset, start symbol, and the number of symbols) are set for the terminal device 40. The terminal device 40 measures the RSSI using the set OFDM symbol.

The SRS-RSRP or the CLI-RSSI measured by the terminal device 40 is reported to the network. The terminal device 40 reports the measurement result of the CLI periodically or at timing when a predetermined event is triggered.

Examples of the trigger condition of the predetermined event include a case where the measurement result of the CLI exceeds a predetermined threshold. A set number of SRS-RSRPs or CLI-RSSIs are reported in descending order of values.

The base station 20 may perform terminal scheduling by using the measurement result of the CLI reported from the terminal device 40. Specifically, the base station 20 may determine the TDD configuration, physical channel configuration, PUSCH/PDSCH scheduling, resource block allocation, and the like of each terminal device 40 by using the measurement result of the CLI.

### [Inter-Base Station Interference Measurement]

In 3GPP (registered trademark), inter-base station interference is measured by using a remote interference management reference signal (RIM-RS). The RIM-RS may be used by the base station 20 to measure inter-cell interference and to provide information about estimated interference to other base stations 20.

Two different types of RIM-RSs may be set. The first RIM-RS type may be used to carry information. The second RIM-RS type is based on settings.

The resource on which the RIM-RS is transmitted is set by operations, administration and maintenance (OAM). Specifically, the OAM sets ON/OFF of RIM-RS monitoring, periodic RIM-RS monitoring information, and reporting of necessary information derived from dedicated RIM-RS to the base station 20.

### <<3. In-Band Full-duplex Communication>>

<3.1. Overview of In-Band Full-Duplex Communication>

With the rapid increase in mobile traffic in recent years, innovative technologies for improving the frequency utilization efficiency have been actively studied. As one type of representative technology, in-band full-duplex communication is studied as described above. The communication system 1 according to the present embodiment performs FD. Therefore, the in-band full-duplex communication will be described.

In the Full Duplex of the related art, in order to avoid radio interference between a transmission signal and a reception signal, communication is performed using different frequencies in a transmission band and a reception band. On the other hand, in-band full-duplex communication is a duplex system in which transmission and reception are simultaneously performed using the same band.

In the in-band full-duplex communication, a signal transmitted by a communication device is received by its own reception antenna or leaks into a reception circuit of the communication device, thereby causing quite intense self-interference. However, the progress of interference canceller technology has made it possible to reduce this self-interference. Hereinafter, when simply referred to as full-duplex communication (FD), the full-duplex communication (FD) refers to in-band full-duplex communication.

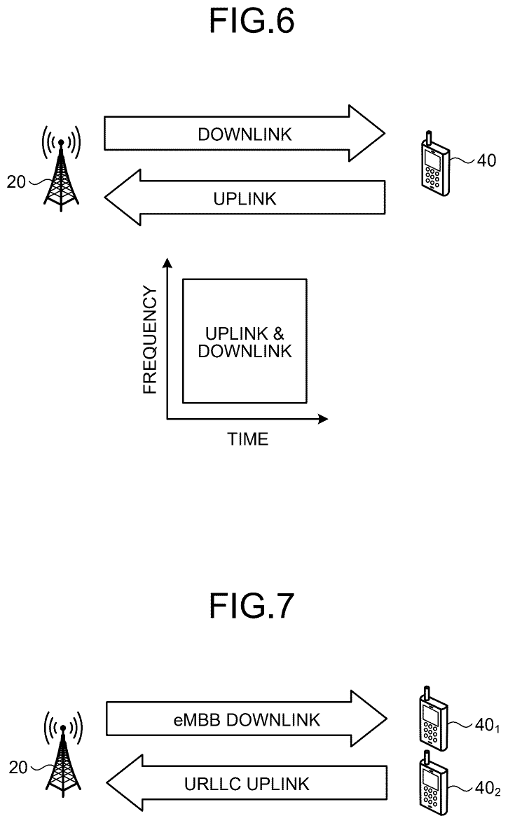

FIG. 6 is a diagram illustrating an overview of in-band full-duplex communication. The uplink and the downlink between the base station 20 and the terminal device 40 illustrated in FIG. 6 adopt in-band full-duplex communication capable of simultaneously communicating transmission and reception using the same frequency band. As a result, in the in-band full-duplex communication, since transmission and reception can be simultaneously communicated using the same frequency band, the frequency utilization efficiency can be doubled as compared with that of out-of-band full-duplex communication.

Note that, in FIG. 6, the base station 20 and the terminal device 40 perform IBFD using resources of the same frequency band and the same time in the uplink and the downlink; however, the frequency band and the time may not both be the same entirely. For example, it suffices that at least a part of the uplink and downlink frequency bands or time overlap with each other, and the uplink and downlink frequency bands and time may not be completely the same.

When the base station 20 and the terminal device 40 use the same or overlapping frequency resources and the same or overlapping time resources in the uplink and the downlink, it is desirable to mount a self-interference canceller for eliminating or reducing self-interference.

Note that, hereinafter, the same or overlapping frequency resources and the same or overlapping time resources may be simply referred to as the same resources in order to simplify the description.

Furthermore, in 5G, in addition to enhanced mobile broadband (eMBB) of data communication of the smartphones in the related art, it is presumed that one wireless system supports a communication mode, such as ultra-reliable and low latency communication (URLLC), which is required to be highly reliable and have low latency, used in emergency message transmission used for autonomous driving.

Postulating introduction of the in-band full-duplex communication technology, transmission and reception of data of different communication use cases can be performed simultaneously.

FIG. 7 is a diagram illustrating an example of the communication method of eMBB and URLLC. The base station 20 transmits an eMBB signal to the terminal device 40₁ using the downlink and receives an URLLC signal from the terminal device 40₂ using the uplink.

For example, in a case where a URLLC signal (URLLC packet), for which low latency is required, is generated while the base station 20 is in the middle of receiving the eMBB signal (eMBB packet), the terminal device 40₂ starts transmission of the URLLC signal without waiting for completion of reception by the base station 20. Since the base station 20 and the terminal device 40 can perform transmission and reception at the same time, it is possible to shorten a transmission standby delay and to secure quality of service (QoS) of the URLLC packet as compared with those of a TDD system.

Note that FIG. 7 illustrates a case where the base station 20 transmits the eMBB signal to the terminal device 40 using the downlink and receives the URLLC signal from the terminal device 40 using the uplink; however, the signals transmitted and received by the base station 20 are not limited thereto. For example, the base station 20 may transmit the URLLC signal to the terminal device 40 using the downlink while receiving the eMBB signal from the terminal device 40 using the uplink.

In this case, cross-link interference is noted as a technical disadvantage of the in-band full-duplex communication. Here, in order to simplify the description, it is based on the premise that the cross-link interference is interference between the terminal devices 40.

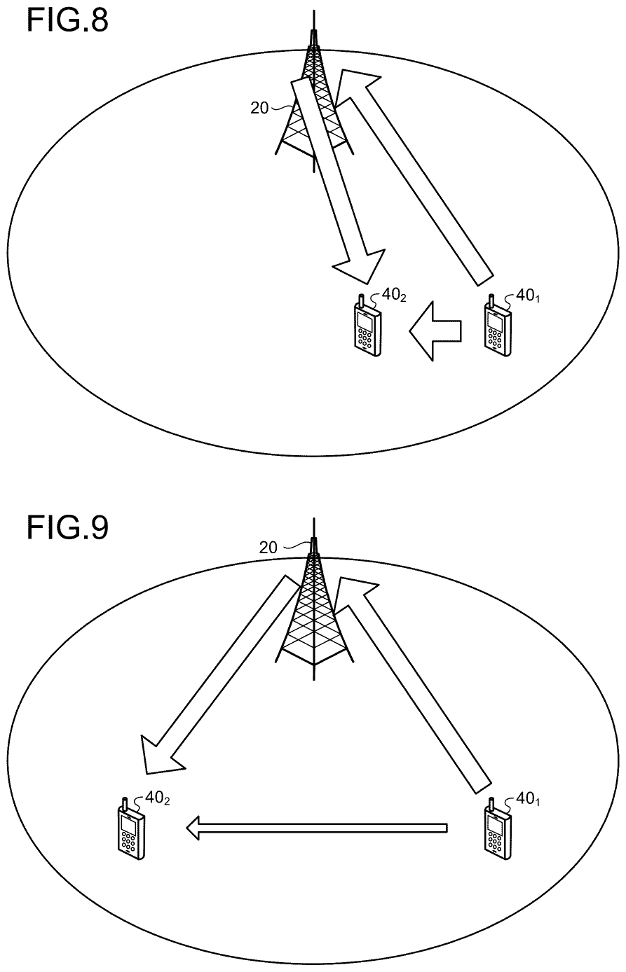

FIGS. 8 and 9 are diagrams for explaining interference between the terminal devices 40 that occurs during an in-band full-duplex communication operation by the base station 20. FIGS. 8 and 9 illustrate interference between the terminal devices 40 generated at the time of communication illustrated in FIG. 7, for example.

As illustrated in FIG. 8, in a cell in which the in-band full-duplex communication is performed, the terminal device 40₁ transmits an uplink signal to the base station 20, and the other terminal device 40₂ in the same cell simultaneously receives a downlink signal from the base station 20. In this case, the uplink signal transmitted by the terminal device 40₁ disadvantageously interferes with reception of the downlink signal of the other terminal device 40₂.

In order to reduce the influence of interference between the terminal devices 40, for example, as illustrated in FIG. 9, it is necessary for the base station 20 to search for an appropriate combination of terminal devices 40 such as receiving an uplink signal from the terminal device 40₁ that is away from the terminal device 40₂.

In this manner, the base station 20 can execute the in-band full-duplex communication by searching for an appropriate combination of the terminal device 40₂ that receives the downlink signal and the terminal device 40₁ that transmits the uplink signal (terminal-terminal pairing). As a result, the base station 20 can improve the frequency utilization efficiency.

Furthermore, another example of solving the cross-link interference is the above-described interference (noise) cancellation technology. In general, when implementing transmission by in-band full-duplex communication, an analog interference canceller and a digital interference canceller are applied. Compared with a digital interference canceller, an analog interference canceller tends to have a lower interference cancellation capability.

### [Summary of Disadvantage]

In addition to the disadvantage of the cross-link interference described above, in a case where the communication system 1 performs asynchronous in-band full-duplex communication, a disadvantage may occur depending on the manner how uplink (UL) communication and downlink (DL) communication are multiplexed.

For example, in a case where the above-described digital interference canceller is applied, the entire signal that is interfering is required for interference cancellation.

In conventional in-band full-duplex communication (for example, synchronous in-band full-duplex communication), frame start timing and end timing coincide with each other in UL communication and DL communication. Therefore, the entire signal that is interfering is always complete within the frame. Note that the frame can be rephrased as a sub frame, a slot, a sub slot, and the like. Hereinafter, in order to simplify the description, it is based on the premise that synchronization of UL communication and DL communication means that start timing and end timing of a frame coincide with each other.

On the other hand, in the asynchronous in-band full-duplex communication, UL communication and DL communication may be multiplexed by the in-band full-duplex communication across frames. In this case, in order for the base station 20 or the terminal device 40 to apply the interference canceller, there occurs standby until the end of the frame, and a delay occurs. In particular, in such a situation in which the asynchronous in-band full-duplex communication is continuously performed, standby until the end of the frame occurs in a chained manner, and an enormous standby time occurs. As a result, the asynchronous FD itself cannot be performed in some cases.

### [Overview of Proposed Technology]

Therefore, in the present embodiment, the following means solves the disadvantage that a delay occurs when asynchronous in-band full-duplex communication is performed.

For example, a communication device (for example, the base station 20 or the terminal device 40) includes a control unit (for example, the control unit 23 or 43). The control unit determines whether or not the digital interference canceller is applicable to a reception signal received in in-band full-duplex communication.

In a case where it is determined that the digital interference canceller is not applicable, the control unit determines whether or not to apply the digital interference canceller to the reception signal. In a case where it is determined to apply the digital interference canceller, the control unit determines to perform preprocessing (an example of processing) for applying the digital interference canceller with another communication device with which the in-band full-duplex communication is performed.

For example, the preprocessing is an operation of establishing synchronization between different communication devices that perform in-band full-duplex communication. As a result, even in a case where asynchronous in-band full-duplex communication is performed, the other communication device can perform synchronous in-band full-duplex communication, whereby occurrence of a delay can be suppressed.

For example, let us postulate that the base station 20 (an example of communication device) receives an URLLC signal from the terminal device 40₂ while transmitting an eMBB signal to the terminal device 40₁. In this case, when the base station 20 receives the URLLC signal by asynchronous in-band full-duplex communication, a delay may occur, and the low delay required for the URLLC signal may not be satisfied.

Therefore, in the present embodiment, the base station 20 determines whether or not to apply the digital interference canceller in a case where a delay occurs when the digital interference canceller is applied to reception of the URLLC signal, and the digital interference canceller is not applicable as it is.

In a case where it is determined to apply the digital interference canceller, the base station 20 determines to perform, as the preprocessing for applying the canceller, synchronization processing with, for example, a terminal device 40 (an example of the other communication device) that performs UL communication and DL communication in in-band full-duplex communication. The base station 20 performs synchronous in-band full-duplex communication with the terminal device 40 by performing synchronization processing with the terminal device 40.

As a result, the base station 20 can further reduce the delay that occurs when receiving the URLLC signal from the terminal device 40₂.

Note that in this example, the preprocessing is processing of synchronizing with the other communication device with which the in-band full-duplex communication is performed; however, the preprocessing is not limited thereto. For example, the preprocessing may be an operation of stopping transmission in a frame at corresponding timing. In this case, as the preprocessing, the base station 20 performs processing of stopping transmission of the eMBB signal to the terminal device 40₁ while receiving the URLLC signal from the terminal device 40₂.

As described above, even in a situation where the interference canceller cannot be originally applied in the environment where asynchronous in-band full-duplex communication is performed, the communication system 1 according to the present embodiment can perform interference cancellation by performing the preprocessing for applying the canceller. As a result, the communication system 1 can implement more efficient transmission and asynchronous in-band full-duplex communication.

### <3.2. Details of In-Band Full-Duplex Communication>

### [Full Duplex in Present Embodiment]

Full Duplex (hereinafter, also referred to as FD) in the present embodiment is a multiplexing scheme in which transmission and reception are simultaneously performed in a predetermined wireless station (communication device).

The Full Duplex includes two types: a method of performing simultaneous transmission and reception using different frequencies divided by a guard band (out-band full duplex: OBFD); and a method of performing simultaneous transmission and reception within the same band (in-band full-duplex: IBFD).

A communication device that performs out-band full duplex reduces leakage interference from transmission by technology such as a guard band or a frequency filter. Meanwhile, a communication device that performs in-band full-duplex reduces leakage interference from transmission by self-interference canceller technology such as antenna-level canceling, analog canceling, and/or digital canceling.

Hereinafter, in the present embodiment, when simply referred to as full duplex (FD), it refers to in-band full-duplex (in-band full duplex communication).

### [Interference Canceller of Present Embodiment]

As described above, the interference canceller is mounted in the communication device according to the present embodiment (for example, the base station 20, the relay station 30, or the terminal device 40). In the communication device, for example, at least one of a self-interference canceller, a cross-link interference canceller, or an inter-cell interference canceller is mounted. For example, the inter-cell interference canceller is mounted in the base station 20.

Here, examples of the interference canceller that can be implemented in the communication system 1 of the embodiment are listed.
Interference canceller using channel information
Symbol-level canceller
Bit-level canceller

Examples of the interference canceller using channel information include the following cancellers.
Minimum Mean Square Error (MMSE)-Interference Rejection Combining (IRC)
Interference alignment
Nulling

Examples of the bit-level canceller include the following cancellers.
Serial Interference Cancellation (SIC)
Parallel Interference Cancellation (PIC)
Elementary Signal Estimator (ESE)
Expectation Propagation Algorithm (EPA)-hybrid Interference Canceller(IC)
Blind Detection Algorithm

### [Example of Asynchronous FD]

Hereinafter, an example of a mode of asynchronous FD communication will be described.

The following two cases of a combination of UL communication and DL communication in FD communication are described.

(Case 1) A case where UL communication and DL communication of FD are performed with the same single wireless station

(Case 2) A case where UL communication or DL communication of FD is performed with different wireless stations

FIG. 10 is a diagram illustrating an example of asynchronous FD communication. In FIG. 10, asynchronous FD communication in case 1 is illustrated.

As illustrated in FIG. 10, in case 1, UL communication and DL communication of the FD are performed with the same wireless station (in this example, the base station 20 and the terminal device 40).

Case 2 is further subdivided into, for example, the following three cases.
(2-A) A case where a base station 20 performs FD with different terminal devices 40
(2-B) A case where a relay station 30 performs FD with a base station 20 and a terminal device 40
(2-C) A case where a terminal device 40₁ performs FD with a base station 20 and another terminal device 40₂.

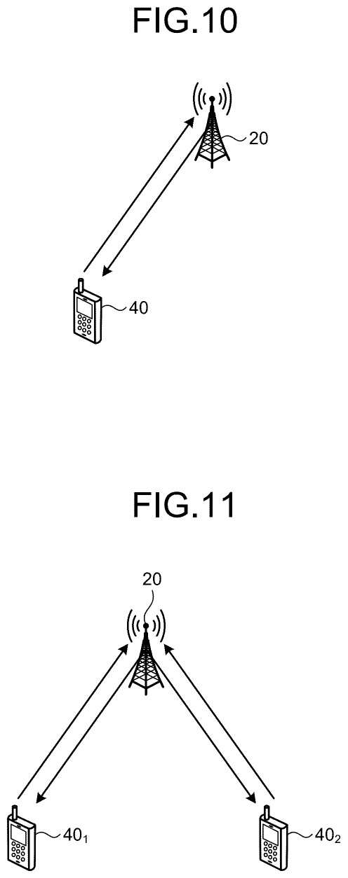

FIG. 11 is a diagram illustrating another example of asynchronous FD communication. In FIG. 11, asynchronous FD communication in case 2-A is illustrated.

As illustrated in FIG. 11, in case 2-A, UL communication and DL communication of the FD are performed between the base station 20 and different terminal devices 40 (in FIG. 11, terminal devices 40₁ and 40₂).

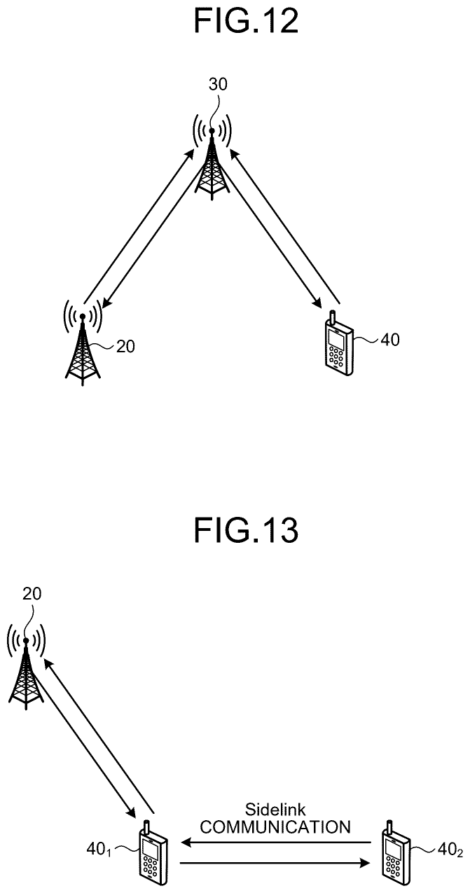

FIG. 12 is a diagram illustrating another example of asynchronous FD communication. In FIG. 12, asynchronous FD communication in case 2-B is illustrated.

As illustrated in FIG. 12, in case 2-B, the relay station 30 performs UL communication and DL communication of the FD with the base station 20 and the terminal device 40.

FIG. 13 is a diagram illustrating another example of asynchronous FD communication. In FIG. 13, asynchronous FD communication in case 2-C is illustrated.

As illustrated in FIG. 13, in case 2-C, the terminal device 40₁ performs UL communication and DL communication of the FD with the base station 20 and the terminal device 40₂. In this case, the communication between the terminal devices 40 is sidelink communication.

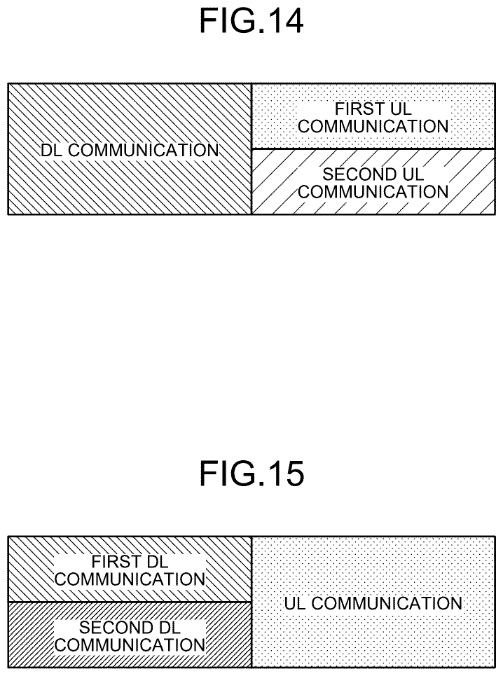

Transmission start timing and transmission end timing (hereinafter, also simply described as communication timing) of UL communication and DL communication in the asynchronous FD are classified into, for example, four patterns (first to fourth communication timing) illustrated in FIGS. 14 to 17 depending on a difference in timing.

### [First Communication Timing]

FIG. 14 is a diagram illustrating an example of first communication timing of asynchronous FD communication. FIG. 14 illustrates a case where a plurality of pieces of UL communication is FD-multiplexed with a single piece of DL communication in such a manner that frame end timings thereof coincide with each other.

In this case, start timing of first UL communication coincides with start timing of the DL communication. In addition, end timing of second UL communication coincides with end timing of the DL communication.

Note that, here, the case where two pieces of UL communication are FD-multiplexed in a form in which the frame end timings thereof coincide with each other with respect to the single DL communication has been described; however, the number of pieces of coincident UL communication is not limited to two. For example, three or more pieces of UL communications may be FD-multiplexed with a single piece of DL communication.

### (Case 1: First Communication Timing)

For example, in case 1 (see FIG. 10) described above, let us postulate that UL communication and DL communication are performed at the first communication timing illustrated in FIG. 14.

In this case, in order for the base station 20 to apply the self-interference canceller to the reception signal received in the UL communication (the first UL communication and/or the second UL communication), the base station 20 needs to wait for completion of its own DL transmission. In other words, after completion of the DL communication, the base station 20 cancels self-interference with respect to the reception signal received in the UL communication.

In order to cancel the self-interference with respect to the reception signal received in the DL communication, the terminal device 40 needs to hold transmission signals transmitted in the first UL communication and the second UL communication during the DL reception.

### (Case 2)

For example, in case 2 (see FIGS. 11 to 13) described above, let us postulate that UL communication and DL are performed at the first communication timing illustrated in FIG. 14.

### (Case 2-A)

For example, in case 2-A, in order for the base station 20 to apply the self-interference canceller to the reception signal received in the UL communication (the first UL communication and/or the second UL communication), the base station 20 needs to wait for completion of its own DL transmission. In other words, after completion of the DL communication, the base station 20 cancels self-interference with respect to the reception signal received in the UL communication.

In order to cancel the self-interference with respect to the reception signal received in the DL communication, the terminal device 40 needs to hold transmission signals transmitted in the first UL communication and the second UL communication during the DL reception.

Furthermore, for example, in case 2-A, in a case where the distance between the terminal devices 40 that receive signals in DL communication is short, cross-link interference occurs.

### (Case 2-B)

Meanwhile, in case 2-B, in order for the relay station 30 (or the base station 20) to apply the self-interference canceller to the reception signal received in the UL communication (the first UL communication and/or the second UL communication), the relay station 30 (or the base station 20) needs to wait for completion of its own DL transmission. In other words, after completion of the DL communication, the relay station 30 (or base station 20) cancels self-interference with respect to the reception signal received in the UL communication.

In order to cancel the self-interference with respect to the reception signal received in the DL communication, the terminal device 40 needs to hold transmission signals transmitted in the first UL communication and the second UL communication during the DL reception.

Furthermore, for example, in case 2-B, in a case where the distance between the terminal device 40 that receive signals in DL communication and the base station 20 is short, cross-link interference occurs.

### (Case 2-C)

Meanwhile, in case 2-C, in order for the base station 20 to apply the self-interference canceller to the reception signal received in the UL communication (the first UL communication and/or the second UL communication), the base station 20 needs to wait for completion of its own DL transmission. In other words, after completion of the DL communication, the base station 20 cancels self-interference with respect to the reception signal received in the UL communication.

In order to cancel the self-interference with respect to the reception signal received in the DL communication, the terminal device 40₁ needs to hold transmission signals transmitted in the first UL communication and the second UL communication during the DL reception.

Furthermore, for example, in case 2-C, in a case where a distance between the terminal device 40₂ that receives a signal in the sidelink communication and the base station 20 or the terminal device 40₁ that performs the FD communication is short, cross-link interference occurs.

### [Second Communication Timing]

FIG. 15 is a diagram illustrating an example of second communication timing of asynchronous FD communication. FIG. 15 illustrates a case where a single piece of UL communication is FD-multiplexed with a plurality of pieces of DL communication in such a manner that frame end timings thereof coincide with each other.

In this case, start timing of first DL communication coincides with start timing of the UL communication. In addition, end timing of second DL communication coincides with end timing of the UL communication.

Note that, here, the case where two pieces of DL communication are FD-multiplexed in a form in which the frame end timings thereof coincide with each other with respect to the single UL communication has been described; however, the number of pieces of coincident DL communication is not limited to two. For example, three or more pieces of DL communications may be FD-multiplexed with a single piece of UL communication.

### (Case 1)

For example, in case 1 (see FIG. 10) described above, let us postulate that UL communication and DL communication are performed at the second communication timing illustrated in FIG. 15.

In this case, in order for the terminal device 40 to apply the self-interference canceller to the reception signal received in the DL communication (the first DL communication and/or the second DL communication), the terminal device 40 needs to wait for completion of its own UL transmission. In other words, after completion of the UL communication, the terminal device 40 cancels self-interference with respect to the reception signal received in the DL communication.

In order to cancel the interference with respect to the reception signal received in the UL communication, the base station 20 needs to hold transmission signals transmitted in the first DL communication and the second DL communication during the UL reception.

### (Case 2)

For example, in case 2 (see FIGS. 11 to 13) described above, let us postulate that UL communication and DL are performed at the first communication timing illustrated in FIG. 14.

### (Case 2-A)

For example, in case 2-A, in order for the base station 20 to cancel the interference with the reception signal received in the UL communication, the base station 20 needs to hold transmission signals transmitted in the first DL communication and the second DL communication during the UL reception.

In order for the terminal device 40 to apply the self-interference canceller to the reception signal received in the DL communication (the first DL communication and/or the second DL communication), the terminal device 40 needs to wait for completion of its own UL transmission. In other words, after completion of the UL communication, the terminal device 40 cancels self-interference with respect to the reception signal received in the DL communication.

Furthermore, for example, in case 2-A, in a case where the distance between the terminal devices 40 that receive signals in DL communication is short, cross-link interference occurs.

### (Case 2-B)

Meanwhile, in case 2-B, in order for the relay station 30 (or the base station 20) to cancel the interference with respect to the reception signal received in the UL communication, the relay station 30 (or the base station 20) needs to hold transmission signals transmitted in the first DL communication and the second DL communication during the UL reception.

In order for the terminal device 40 to apply the self-interference canceller to the reception signal received in the DL communication (the first DL communication and/or the second DL communication), the terminal device 40 needs to wait for completion of its own UL transmission. In other words, after completion of the UL communication, the terminal device 40 cancels self-interference with respect to the reception signal received in the DL communication.

Furthermore, for example, in case 2-B, in a case where the distance between the terminal device 40 that receive signals in DL communication and the base station 20 is short, cross-link interference occurs.

### (Case 2-C)

Meanwhile, in case 2-C, in order for the base station 20 to cancel the interference with the reception signal received in the UL communication, the base station 20 needs to hold transmission signals transmitted in the first DL communication and the second DL communication during the UL reception.

In order for the terminal device 40₁ to apply the self-interference canceller to the reception signal received in the DL communication (the first DL communication and/or the second DL communication), the terminal device 40₁ needs to wait for completion of its own UL transmission. In other words, after completion of the UL communication, the terminal device 40₁ cancels self-interference with respect to the reception signal received in the DL communication.

Furthermore, for example, in case 2-C, in a case where a distance between the terminal device 40₂ that receives a signal in the sidelink communication and the base station 20 or the terminal device 40₁ that performs the FD communication is short, cross-link interference occurs.

### [Third Communication Timing]

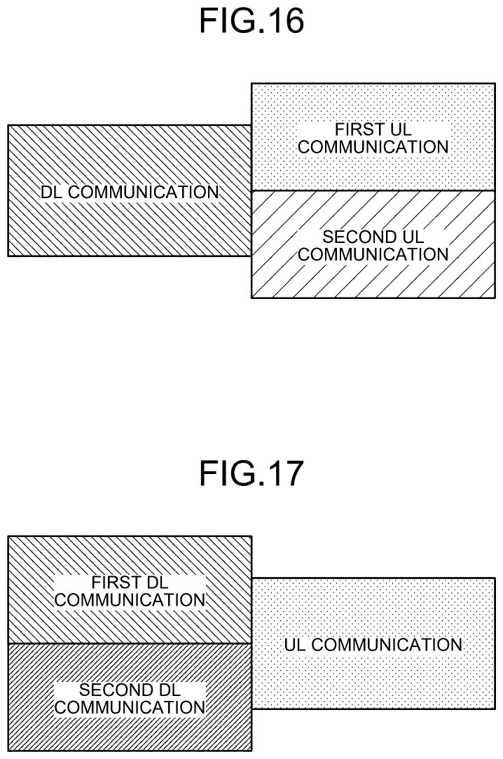

FIG. 16 is a diagram illustrating an example of third communication timing of asynchronous FD communication. FIG. 16 illustrates a case where a plurality of pieces of UL communication is FD-multiplexed with a single piece of DL communication in such a manner that frame end timings thereof do not coincide with each other.

For example, start timing of first UL communication does not coincide with start timing of the DL communication. In the example of FIG. 16, the start timing of the first UL communication is earlier than the start timing of the DL communication. In addition, end timing of second UL communication does not coincide with end timing of the DL communication. In the example of FIG. 16, the end timing of the second UL communication is later than the end timing of the DL communication.

### (Case 1)

For example, in case 1 (see FIG. 10) described above, let us postulate that UL communication and DL communication are performed at the third communication timing illustrated in FIG. 16.

In this case, in order to cancel the self-interference with respect to the signal received in the first UL communication, the base station 20 needs to wait for completion of its own DL transmission. In order to cancel the self-interference with respect to the signal received in the second UL communication, the base station 20 needs to hold the signal transmitted in the DL communication.

In order to cancel the self-interference with respect to the signal received in the DL communication, the terminal device 40 needs to hold both the signal transmitted in the first UL communication and the signal transmitted in the second UL communication.

### (Case 2)

For example, in case 2 (see FIGS. 11 to 13) described above, let us postulate that UL communication and DL are performed at the third communication timing illustrated in FIG. 16.

### (Case 2-A)

For example, in case 2-A, in order to cancel the self-interference with respect to the signal received in the first UL communication, the base station 20 needs to wait for completion of its own DL transmission. In order to cancel the self-interference with respect to the signal received in the second UL communication, the base station 20 needs to hold the signal transmitted in the DL communication.

In order to cancel the self-interference with respect to the signal received in the DL communication, the terminal device 40 needs to hold both the signal transmitted in the first UL communication and the signal transmitted in the second UL communication.

Furthermore, for example, in case 2-A, in a case where the distance between the terminal devices 40 that receive signals in DL communication is short, cross-link interference occurs.

### (Case 2-B)

Meanwhile, in case 2-B, in order to cancel the self-interference with respect to the signal received in the first UL communication, the relay station 30 (or the base station 20) needs to wait for completion of its own DL transmission. In order to cancel the self-interference with respect to the signal received in the second UL communication, the relay station 30 (or the base station 20) needs to hold the signal transmitted in the DL communication.

In order to cancel the self-interference with respect to the signal received in the DL communication, the terminal device 40 needs to hold both the signal transmitted in the first UL communication and the signal transmitted in the second UL communication.

Furthermore, for example, in case 2-B, in a case where the distance between the terminal device 40 that receive signals in DL communication and the base station 20 is short, cross-link interference occurs.

### (Case 2-C)

Meanwhile, in case 2-C, in order to cancel the self-interference with respect to the signal received in the first UL communication, the base station 20 needs to wait for completion of its own DL transmission. In order to cancel the self-interference with respect to the signal received in the second UL communication, the base station 20 needs to hold the signal transmitted in the DL communication.

In order to cancel the self-interference with respect to the signal received in the DL communication, the terminal device 40 needs to hold both the signal transmitted in the first UL communication and the signal transmitted in the second UL communication.

Furthermore, for example, in case 2-C, in a case where a distance between the terminal device 40₂ that receives a signal in the sidelink communication and the base station 20 or the terminal device 40₁ that performs the FD communication is short, cross-link interference occurs.

### [Fourth Communication Timing]

FIG. 17 is a diagram illustrating an example of fourth communication timing of asynchronous FD communication. FIG. 17 illustrates a case where a single piece of UL communication is FD-multiplexed with a plurality of pieces of DL communication in such a manner that frame end timings thereof do not coincide with each other.

For example, start timing of first DL communication does not coincide with start timing of the UL communication. In the example of FIG. 17, the start timing of the first DL communication is earlier than the start timing of the UL communication. In addition, end timing of second DL communication does not coincide with end timing of the UL communication. In the example of FIG. 17, the end timing of the second DL communication is later than the end timing of the UL communication.

### (Case 1)

For example, in case 1 (see FIG. 10) described above, let us postulate that UL communication and DL communication are performed at the fourth communication timing illustrated in FIG. 17.

In this case, in order to cancel the self-interference with respect to the signal received in the first DL communication, the terminal device 40 needs to wait for completion of its own UL transmission. In order to cancel the self-interference with respect to the signal received in the second DL communication, the terminal device 40 needs to hold the signal transmitted in the UL communication.

In order to cancel the self-interference with respect to the signal received in the UL communication, the base station 20 needs to hold both the signal transmitted in the first DL communication and the signal transmitted in the second DL communication.

### (Case 2)

For example, in case 2 (see FIGS. 11 to 13) described above, let us postulate that UL communication and DL are performed at the fourth communication timing illustrated in FIG. 17.

### (Case 2-A)

For example, in case 2-A, in order to cancel the self-interference with respect to the signal received in the UL communication, it is necessary to hold both the signal transmitted in the first DL communication and the signal transmitted in the second DL communication.

In order to cancel the self-interference with respect to the signal received in the first DL communication, the terminal device 40 needs to wait for completion of its own UL transmission. In order to cancel the self-interference with respect to the signal received in the second DL communication, the terminal device 40 needs to hold the signal transmitted in the UL communication.

Furthermore, for example, in case 2-A, in a case where the distance between the terminal devices 40 that receive signals in DL communication is short, cross-link interference occurs.

### (Case 2-B)

In addition, in case 2-B, in order to cancel the self-interference with respect to the signal received in the UL communication, the relay station 30 (or the base station 20) needs to hold both the signal transmitted in the first DL communication and the signal transmitted in the second DL communication.

In order to cancel the self-interference with respect to the signal received in the first DL communication, the terminal device 40 needs to wait for completion of its own UL transmission. In order to cancel the self-interference with respect to the signal received in the second DL communication, the terminal device 40 needs to hold the signal transmitted in the UL communication.

Furthermore, for example, in case 2-B, in a case where the distance between the terminal device 40 that receive signals in DL communication and the base station 20 is short, cross-link interference occurs.

### (Case 2-C)

In addition, in case 2-C, in order to cancel the self-interference with respect to the signal received in the UL communication, the base station 20 needs to hold both the signal transmitted in the first DL communication and the signal transmitted in the second DL communication.

In order to cancel the self-interference with respect to the signal received in the first DL communication, the terminal device 40 needs to wait for completion of its own UL transmission. In order to cancel the self-interference with respect to the signal received in the second DL communication, the terminal device 40 needs to hold the signal transmitted in the UL communication.

Furthermore, for example, in case 2-C, in a case where a distance between the terminal device 40₂ that receives a signal in the sidelink communication and the base station 20 or the terminal device 40₁ that performs the FD communication is short, cross-link interference occurs.

### <<4. Preprocessing for Applying Interference Canceller>>

As described above, in a case where the asynchronous FD is performed in the communication system 1, the communication device (for example, the base station 20, the relay station 30, or the terminal device 40) cannot cancel self-interference of a reception signal until its own transmission is completed, whereby a delay occurs. For example, in a case where the reception signal is a signal for which a low delay is required, such as a URLLC packet, there are cases where a delay is not allowed.

Therefore, in the communication system 1 according to the present embodiment, the communication device suppresses occurrence of the delay by performing preprocessing for applying the interference canceller. More specifically, the communication device first performs execution determination processing of preprocessing. In a case where it is determined in the execution determination processing that the preprocessing is to be performed, the communication device performs the preprocessing.

The communication device performs, for example, execution determination processing as to whether or not to perform preprocessing in each of an analog interference canceller and a digital interference canceller. Either the execution determination processing of the analog interference canceller or the execution determination processing of the digital interference canceller may be performed first.

Alternatively, one of the execution determination processing of the analog interference canceller and the execution determination processing of the digital interference canceller may be performed, with the other not performed.

### <4.1. Execution Determination Processing>

[Execution Determination Processing of Digital Interference Canceller]

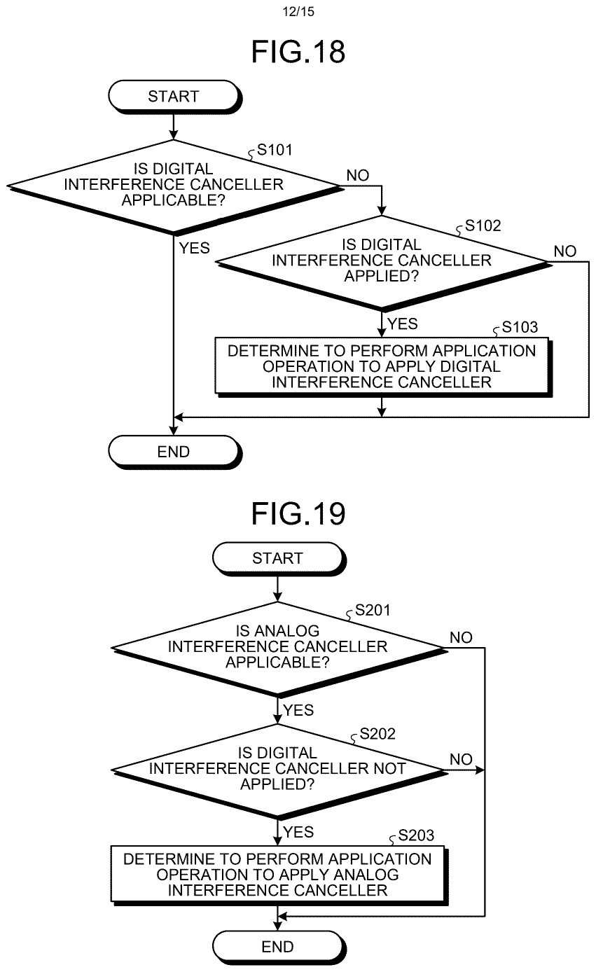

First, an example of the execution determination processing of the digital interference canceller will be described with reference to FIG. 18. FIG. 18 is a flowchart illustrating an exemplary flow of execution determination processing of the digital interference canceller according to the embodiment of the present disclosure. It is based on the premise that the execution determination processing illustrated in FIG. 18 is to be performed by a communication device that performs the preprocessing for applying the interference canceller.

First, the communication device determines whether or not the digital interference canceller is applicable in asynchronous FD communication (step S101). If the digital interference canceller is applicable (step S101; Yes), the communication device ends the processing.

On the other hand, if the digital interference canceller is not applicable (step S101; No), the communication device determines whether or not to apply the digital interference canceller (step S102).

For example, the communication device determines to apply the digital interference canceller in a case of holding traffic for which low latency is desired or traffic with high priority, such as a URLLC packet.

Alternatively, the communications device determines to apply the digital interference canceller in a case where the analog interference canceller is not applicable. Exemplary cases where the analog interference canceller is not applicable include a case where the correlation between an incoming wave and a delayed wave received by the communication device is high and a case where the communication device is not mounted with the analog interference canceller.

If it is determined that the digital interference canceller is applied (step S102; Yes), the communication device determines to perform preprocessing for applying the interference canceller (step S103). Here, details of first preprocessing in which the communication device that has performed the execution determination processing performs preprocessing for applying the digital interference canceller (hereinafter, also referred to as first preprocessing) depending on the determination result will be described later.

Meanwhile, cases where the communication device determines not to apply the digital interference canceller include a case where the communication device determines to apply the analog interference canceller but not to apply the digital interference canceller. For example, the communication device can determine not to apply the digital interference canceller in a case of determining to perform the preprocessing for applying the analog interference canceller in the execution determination processing of the analog interference canceller described later.

Alternatively, the communication device determines not to apply the digital interference canceller in cases such as when giving up performing the FD communication or when the digital interference canceller is not mounted on the communication device itself.

If it is determined that the digital interference canceller is not applied (step S102; No), the communication device ends the execution determination processing.
[Execution Determination Processing of Analog Interference Canceller]

Next, an example of the execution determination processing of the analog interference canceller will be described with reference to FIG. 19. FIG. 19 is a flowchart illustrating an exemplary flow of execution determination processing of the analog interference canceller according to the embodiment of the present disclosure. It is based on the premise that the execution determination processing illustrated in FIG. 19 is to be performed by a communication device that performs the preprocessing for applying the interference canceller.

First, the communication device determines whether or not the analog interference canceller is applicable in asynchronous FD communication (step S201). If the digital interference canceller is not applicable (step S201; No), the communication device ends the processing.

On the other hand, if the analog interference canceller is applicable (step S201; Yes), the communication device determines whether or not the digital interference canceller is not applicable (step S202).

If it is determined that the digital interference canceller is applicable (step S202; No), the communication device ends the processing.

On the other hand, if it is determined that the digital interference canceller is not applied (step S202; Yes), the communication device determines not to apply the digital interference canceller but to perform the preprocessing for applying the analog interference canceller (step S203).

In this example, the communication device that has performed the execution determination processing performs the preprocessing (hereinafter, also referred to as second preprocessing) for applying the analog interference canceller. Details of the second preprocessing will be described later.
[Another Example of Execution Determination]

Note that, although the execution determination processing of the digital interference canceller and the execution determination processing of the analog interference canceller are executed by the communication device that performs the preprocessing in this example; however, the communication device that executes these types of execution determination processing is not limited thereto. For example, in a case where the communication device that performs the preprocessing is the relay station 30 or the terminal device 40, another communication device (for example, the base station 20) may perform the execution determination processing.

In this case, the base station 20 can perform both the execution determination processing of the digital interference canceller and the execution determination processing of the analog interference canceller on behalf of the relay station 30 or the terminal device 40. Alternatively, the base station 20 can perform one of the execution determination processing of the digital interference canceller and the execution determination processing of the analog interference canceller on behalf of the relay station 30 or the terminal device 40.

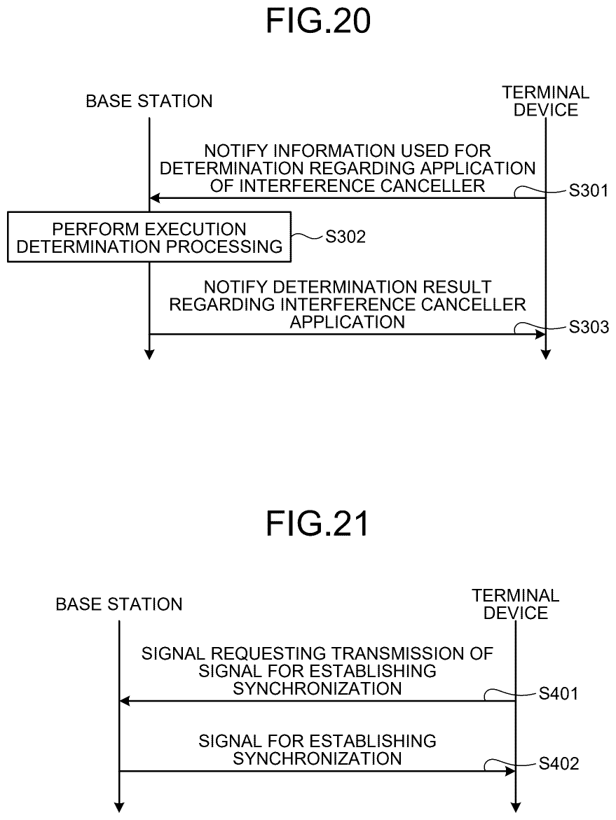

FIG. 20 is a sequence diagram illustrating an exemplary flow of execution determination according to the embodiment of the present disclosure. FIG. 20 illustrates a flow in a case where the base station 20 performs the execution determination processing in response to a request from the terminal device 40. Note that the execution determination of FIG. 20 can be performed between the relay station 30 and the base station 20 instead of the terminal device 40.

As illustrated in FIG. 20, the terminal device 40 notifies information used to determine application of the interference canceller (determination information) (step S301). This determination information is used, for example, in the above-described execution determination processing.

The terminal device 40 transmits the determination information to the base station 20 via, for example, a PUCCH that transmits control information. Alternatively, the terminal device 40 may transmit the determination information to the base station 20 via the PUSCH as control information of the MAC or the RRC layer.

The determination information may include, for example, at least one piece of the following information and the like.
Presence or absence of the interference canceller of the terminal device 40
Performance of the interference canceller included in the terminal device 40
Capability information such as processing performance of the terminal device 40
QoS information of data transmitted by FD communication

The base station 20 performs the execution determination processing using the acquired determination information (step S302). The base station 20 executes at least one of the execution determination processing of the digital interference canceller and the execution determination processing of the analog interference canceller described above.

The base station 20 notifies the terminal device 40 of the determination result regarding interference canceller application which is the processing result (step S303). As a result of the execution determination processing, the base station 20 can notify the terminal device 40 of information used for the preprocessing in addition to the determination result regarding the interference canceller application as to whether or not to perform the preprocessing for applying the interference canceller. The determination result and the information used for the preprocessing are collectively referred to as result information.

The base station 20 transmits the result information via, for example, a PDCCH that transmits control information. Alternatively, the base station 20 can transmit the result information to the terminal device 40 via the PDSCH as control information of the MAC or the RRC layer.

On the basis of the result information, the terminal device 40 determines whether or not to perform the preprocessing for applying the interference canceller with a communication partner with which the FD communication is performed. For example, in a case where the result information includes the processing result indicating that execution of the preprocessing has been determined, the terminal device 40 determines to perform the preprocessing for applying the interference canceller with the communication partner and performs the preprocessing.

### <4.2. First Preprocessing>

### FIRST EXAMPLE

Hereinafter, a first example of the first preprocessing for applying the digital interference canceller will be described. In a case where it is determined that the preprocessing is to be performed in the execution determination processing of the digital interference canceller described above, the communication device performs the first preprocessing. In this example, as the first preprocessing, the communication device performs an operation (synchronization establishment processing) for establishing synchronization with a communication partner of FD communication.

Note that, hereinafter, in order to simplify the description, the synchronization establishment processing is performed between the base station 20 and the terminal device 40; however, this synchronization establishment processing can also be performed between the base station 20 and the relay station 30 or between the relay station 30 and the terminal device 40.

FIG. 21 is a sequence diagram illustrating an exemplary flow of synchronization establishment processing according to the embodiment of the disclosure. In the synchronization establishment processing of FIG. 21, it is based on the premise that the terminal device 40 having determined to perform the first preprocessing establishes synchronization with the base station 20 that is a communication partner.

As illustrated in FIG. 21, the terminal device 40 transmits a signal requesting the base station 20 to transmit a signal for establishing synchronization (step S401).

The base station 20 that has received the request transmits the signal for establishing synchronization to the terminal device 40 (step S402).

As a result, synchronization is established between the base station 20 and the terminal device 40. Thereafter, the base station 20 and the terminal device 40 perform synchronous FD communication and receive an IBFD signal (an example of a reception signal). The base station 20 and the terminal device 40 apply the interference canceller to the IBFD reception signal.

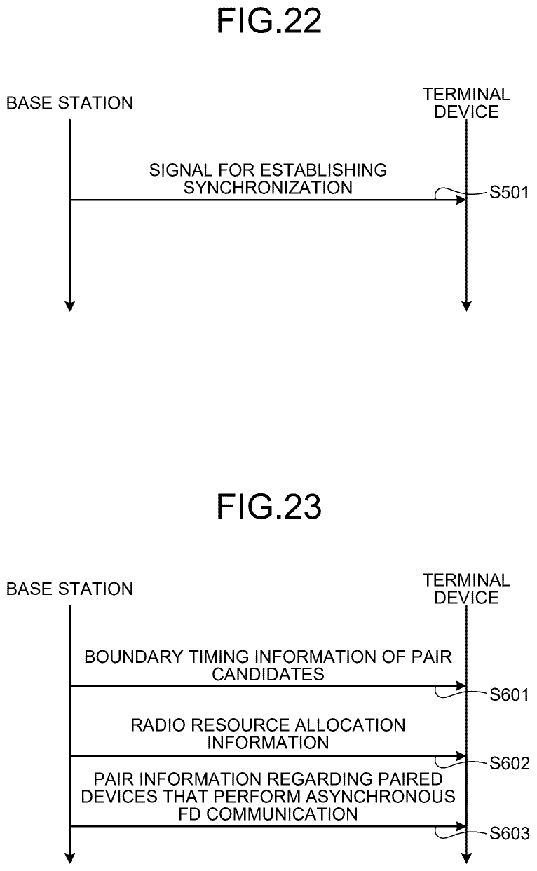

FIG. 22 is a sequence diagram illustrating another exemplary flow of the synchronization establishment processing according to the embodiment of the disclosure. In the synchronization establishment processing of FIG. 22, it is based on the premise that the base station 20 having determined to perform the first preprocessing establishes synchronization with the terminal device 40 that is a communication partner.

As illustrated in FIG. 22, the base station 20 transmits a signal for establishing synchronization to the terminal device 40 (step S501).

As a result, synchronization is established between the base station 20 and the terminal device 40. Thereafter, the base station 20 and the terminal device 40 perform synchronous FD communication.

As described above, in a case where a delay occurs due to application of the digital interference canceller during asynchronous FD communication, the communication system 1 can suppress occurrence of a delay due to the asynchronous FD communication while applying the digital interference canceller by switching to the synchronous FD communication.

### (Signal for Establishing Synchronization)

Next, an example of a signal (hereinafter, also referred to as a synchronization signal) for establishing synchronization transmitted by the base station 20 will be described. For example, at least one piece of the following information is stored in the synchronization signal.
Length information regarding the frame length or the slot length of FD communication
Time point information regarding start and end points of a frame of FD communication
Continuation information regarding the time length for which FD communication is continued
Resource information regarding radio resources with which FD communication is performed
MCS Information when FD Communication is Performed

The length information regarding the frame length or the slot length of FD communication is information of the frame length or the slot length that operates in the FD communication performed between the base station 20 and the terminal device 40 after synchronization is established. This length information can be transmitted as information indirectly expressing slot length information, such as sub carrier spacing (SCS) information.

The time point information regarding the start and end points of the frame of FD communication is information of the start point of the FD communication performed between the base station 20 and the terminal device 40 after synchronization is established. The time point information may be information indicating a relative time position such as X ms after the time point at which the synchronization signal is received or may be information designating common time shared between the base station 20 and the terminal device 40 (or the relay station 30) on the basis of GPS or the like.

The continuation information regarding the time length for which FD communication is continued is information of the time length for which FD communication, performed between the base station 20 and the terminal device 40 after establishing synchronization, is continued. The continuation information may be information indicating a specific time length or may be information of the number of repetitions of an operation such as how many times a series of sequences including FD communication and retransmission operation is performed.

The resource information regarding the radio resource for performing FD communication is information regarding radio resources used for the FD communication performed between the base station 20 and the terminal device 40 after synchronization is established. At this point, in a case where different frequency bands are used in the UL communication and the DL communication (OBFD) or in a case where sidelink communication is performed, information designating a resource used in each piece of communication is included.

The MCS information when FD communication is performed is information of a combination of the modulation level and the coding rate used for the FD communication performed between the base station 20 and the terminal device 40.

The synchronization signal is transmitted from the base station 20 to the terminal device 40 (or the relay station 30) that performs FD communication. Alternatively, the synchronization signal may be transmitted to at least one of another terminal device 40 located in the surroundings of the terminal device 40 (or the relay station 30) that performs the FD communication, another relay station 30, or another base station 20.

For example, it is conceivable that another terminal device 40 located in the surroundings performs an operation in accordance with the FD communication synchronized by the synchronization signal. In such a case, the base station 20 can transmit a synchronization signal to another terminal device (or another relay station 30 or another base station 20) in addition to the terminal device 40 that performs the FD communication.

The terminal device 40 that performs the FD communication with the base station 20 performs synchronous FD communication on the basis of the information included in the synchronization signal. As described above, the synchronization signal can be transmitted from the base station 20 on the basis of a request from the terminal device 40 that performs the FD communication. In this case, the terminal device 40 transmits a request signal requesting a synchronization signal to the base station 20.

In this manner, the base station 20 and the terminal device 40 can establish synchronization as necessary in asynchronous FD communication by performing preprocessing (in this example, an operation of establishing synchronization) between the terminal device 40 and the base station 20 that perform FD communication on the basis of a synchronization signal from the base station 20. As a result, the communication system 1 can further suppress the delay that occurs in the asynchronous FD communication.

### SECOND EXAMPLE

Hereinafter, a second example of the first preprocessing for applying the digital interference canceller will be described. In a case where it is determined that the preprocessing is to be performed in the execution determination processing of the digital interference canceller, the communication device performs the first preprocessing. In this example, as the first preprocessing, the communication device performs an operation for performing FD communication depending on the timing of a frame boundary.

Note that, here, it is based on the premise that the base station 20 determines to execute the first preprocessing and executes the first preprocessing from the base station 20 to the terminal device 40 (or the relay station 30); however, the communication device that determines execution of the first preprocessing is not limited to the base station 20. The terminal device 40 (or the relay station 30) may determine execution of the first preprocessing. In this case, the terminal device 40 (or the relay station 30) that has determined to execute the first preprocessing can request the base station 20 to execute the first preprocessing.

FIG. 23 is a sequence diagram illustrating an exemplary flow of first preprocessing according to the embodiment of the disclosure.

The base station 20 that performs asynchronous FD communication acquires boundary timing information regarding the timing of a boundary of a frame of the communication devices that can be paired to perform the asynchronous FD communication (hereinafter, also referred to as pair candidates) and notifies subordinate terminal devices 40 (or relay stations 30) of the boundary timing information (step S601).

In this example, the base station 20 may collectively notify the boundary timing information or may notify the boundary timing information regarding the communication devices that perform the asynchronous FD communication for each piece of asynchronous FD communication to be performed.

The boundary timing information is, for example, information regarding the timing of a frame boundary when the pair candidates of the asynchronous FD communication perform the asynchronous FD communication.

The boundary timing information may be, for example, information indicating a relative time position such as X ms after the frame boundary timing of its own (base station 20) or may be information designating common time shared between communication devices that perform asynchronous FD communication on the basis of GPS.

Furthermore, in a case where a frame of the communication device to which the boundary timing information is notified is divided into a plurality of frames, the boundary timing information may be information indicating in which divided frame the timing of the frame boundary is positioned.

The base station 20 transmits the boundary timing information as control information via the PDCCH, for example. Alternatively, the base station 20 transmits the boundary timing information as control information of the MAC or the RRC layer via the PDSCH.

Next, the base station 20 acquires allocation information regarding the radio resource allocation related to the asynchronous FD communication and notifies the subordinate terminal devices 40 (or relay stations 30) of the allocation information (step S602).

In addition, when the radio resources are allocated by the allocation information, the base station 20 acquires pair information regarding communication devices to be paired for performing the asynchronous FD communication (hereinafter, also referred to as paired devices) and notifies the subordinate terminal devices 40 (or relay stations 30) of the pair information (step S603).

The base station 20 transmits the pair information as control information via the PDCCH, for example. Alternatively, the base station 20 transmits the pair information as control information of the MAC or the RRC layer via the PDSCH.

Note that FIG. 23 illustrates a case where the base station 20 transmits the allocation information and the pair information as separate signals; however, the method of transmitting the allocation information and the pair information is not limited thereto. For example, the base station 20 may transmit the allocation information and the pair information by the same single signal.

The terminal device 40 (or the relay station 30) that performs asynchronous FD communication performs transmission of asynchronous FD such that a signal can be decoded at a frame boundary of the communication device that performs the asynchronous FD communication on the basis of the boundary timing information that has been received in advance. Similarly, the base station 20 that performs the asynchronous FD communication performs transmission of asynchronous FD such that a signal can be decoded at a frame boundary of the communication device that performs the asynchronous FD communication on the basis of the boundary timing information that has been received in advance.

Examples of the asynchronous FD transmission in which a signal can be decoded at a frame boundary of a communication device that performs the asynchronous FD communication include a method of providing a buffer interval at the position of the frame boundary.

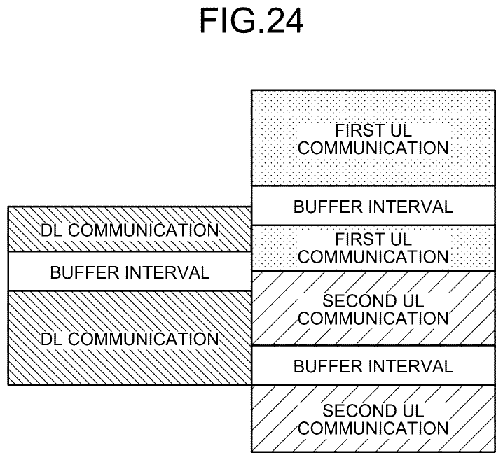

FIG. 24 is a diagram for describing an example of asynchronous FD transmission according to the embodiment of the present disclosure. As illustrated in FIG. 24, the base station 20 performs asynchronous FD communication with the terminal device 40 (or the relay station 30).

It is based on the premise that the base station 20 holds in advance boundary timing information regarding the timing of the boundary (in the example of FIG. 24, boundary timing between first UL communication and second UL communication) of a frame of the terminal device 40 which is the communication partner of the asynchronous FD communication.

The base station 20 performs DL communication by providing a buffer interval to boundary timing of a frame of UL communication. As a result, the terminal device 40 can apply the interference canceller to a DL signal without waiting for completion of transmission of a signal transmitted in the first UL communication before the buffer interval and a signal transmitted in the second UL communication after the buffer interval.

It is also based on the premise that the terminal device 40 has received boundary timing information regarding the timing of the boundary of a frame of the base station 20 (in the example of FIG. 24, start timing and end timing of the DL communication) which is the communication partner of the asynchronous FD communication in advance.

The terminal device 40 performs the first UL communication and the second UL communication by providing the buffer interval at the boundary timing of a frame of the DL communication (in the example of FIG. 24, the start timing and the end timing of the DL communication).

As a result, the base station 20 can apply the interference canceller to a signal received in the first UL communication without waiting for completion of transmission of a signal transmitted in the DL communication after the buffer interval. Furthermore, even if the base station 20 does not hold the signal transmitted in the DL communication before the buffer interval, the interference canceller can be applied to the signal transmitted in the second UL communication before the buffer interval. Therefore, the base station 20 can further reduce the delay due to the asynchronous FD communication.

As described above, with the communication device that performs asynchronous FD communication setting the buffer interval, a signal can be received in a decodable state at the frame boundary even in a case where the frame interval is shifted between communication devices that perform the asynchronous FD communication.

Note that the buffer interval may be an interval in which no signal is transmitted or may be an interval in which a signal of a known sequence is transmitted. By transmitting the signal of the known sequence in the buffer interval, the communication device can detect a break (frame boundary timing) of a frame interval of the communication partner.

In this manner, the communication device performs asynchronous FD transmission on the basis of the boundary timing information and the pair information such that a signal can be decoded at the frame boundary. As a result, the communication partner of the asynchronous FD communication can extract a portion that causes interference of its own signal with respect to a signal transmitted across its own frame boundary and apply the interference canceller. As a result, the communication device that performs the asynchronous FD can perform reception processing to which the digital interference canceller is applied at the time of receiving its own signal.

### <4.3. Second Preprocessing>

Next, the second preprocessing for applying the analog interference canceller will be described. As described above, the communication device performs the second preprocessing, for example, in a case where it is determined not to apply the digital interference canceller but to apply the analog interference canceller.

For example, the communication device performs notification of MCS to be used in a case where the analog interference canceller is applied as the second preprocessing. At this point, the communication device performs measurement in order to determine the communication partner of the FD communication to which the analog interference canceller is applied and a corresponding MCS table. For example, the communication device measures the reception SINR to determine MCS to be used in the asynchronous FD communication.

### <<5. Other Embodiments>>

Note that the above embodiments are examples, and various modifications and applications can be made.

For example, a control device that controls the base stations 20, the relay stations 30, and the terminal devices 40 of the embodiments described above may be implemented by a dedicated computer system or a general-purpose computer system.

For example, a communication program for executing the above operations is stored and distributed in a computer-readable recording medium such as an optical disc, a semiconductor memory, a magnetic tape, or a flexible disk. Moreover, for example, the control device is configured by installing the program in a computer and executing the processing described above. At this point, the control device may be a device external to the base stations 20 and the terminal devices 40 (for example, a personal computer). Furthermore, the control device may be an internal device of the base stations 20, the relay stations 30, or the terminal devices 40 (for example, the control unit 23, 33, or 43).

In addition, the communication program may be stored in a disk device included in a server device on a network such as the Internet so that the communication program can be downloaded to a computer. In addition, the above functions may be implemented by collaborative operation between an operating system (OS) and application software. In this case, a portion other than the OS may be stored in a medium and distributed, or a portion other than the OS may be stored in a server device to allow a computer to download it, for example.

Among the pieces of processing described in the above embodiments, all or a part of processing described as that performed automatically can be performed manually, or all or a part of processing described as that performed manually can be performed automatically by a known method. In addition, a processing procedure, a specific name, and information including various types of data or parameters illustrated in the above or in the drawings can be modified as desired unless otherwise specified. For example, various types of information illustrated in the drawings are not limited to the information illustrated.

In addition, each component of each device illustrated in the drawings is conceptual in terms of function and is not necessarily physically configured as illustrated in the drawings. That is, the specific form of distribution and integration of devices is not limited to those illustrated in the drawings, and all or a part thereof can be functionally or physically distributed or integrated in any unit depending on various loads, use status, or others. Note that this configuration by distribution or integration may be performed dynamically.

In addition, the above embodiments can be combined as appropriate as long as the processing content does not contradict each other. In addition, the order of the steps illustrated in the sequence diagrams of the above embodiments can be modified as appropriate.

Furthermore, for example, the present embodiment can be implemented as any configuration including a device or a system, for example, a processor such as a system large scale integration (LSI), a module using a plurality of processors or the like, a unit using a plurality of modules or the like, a set or the like (namely, some components of a device) obtained by further adding another function to a unit.

Note that, in the present embodiment, a system refers to a set of a plurality of components (devices, modules (parts), etc.), and it does not matter whether or not all the components are in the same housing. Therefore, a plurality of devices, housed in separate housings and coupled via a network, and one device, in which a plurality of modules is housed in one housing, are both systems.

Furthermore, for example, the present embodiment can adopt a configuration of cloud computing in which one function is shared and processed by a plurality of devices in cooperation via a network.

### <<6. Conclusion>>

Although the embodiments of the disclosure have been described above, the technical scope of the disclosure is not limited to the above embodiments as they are, and various modifications can be made without departing from the gist of the disclosure. In addition, components of different embodiments and modifications may be combined as appropriate.

Furthermore, the effects of the embodiments described herein are merely examples and are not limiting, and other effects may be achieved.

Note that the present technology can also have the following configurations.

(1)

A Communication Device Comprising:
a control unit that:
determines whether or not a digital interference canceller is applicable to a reception signal received by in-band full-duplex communication;
determines whether or not to apply the digital interference canceller to the reception signal in a case where it is determined that the digital interference canceller is not applicable; and
in a case where it is determined to apply the digital interference canceller, determines to perform processing for applying the digital interference canceller with another communication device that performs the in-band full-duplex communication.
   (2)

The communication device according to (1), wherein

the reception signal is a signal received by the other communication device from a communication partner, and
the other communication device executes the processing with the communication partner in a case where the control unit determines to perform the processing.
(3)

The communication device according to (2), wherein the control unit determines whether or not to perform the processing on a basis of determination information acquired from the other communication device.

(4)

The communication device according to any one of (1) to (3), wherein the control unit transmits, as the processing, a synchronization signal for establishing synchronization with the other communication device.

(5)

The communication device according to (4), wherein the synchronization signal includes at least one of information of a frame length or a slot length of the in-band full-duplex communication, information of a start point and/or an end point of a frame of the in-band full-duplex communication, information of a radio resource for performing the in-band full-duplex communication, or MCS information at a time of performing the in-band full-duplex communication.

(6)

The communication device according to (1), wherein the control unit requests the other communication device to transmit a signal for establishing synchronization in order to establish synchronization as the processing.

(7)

The communication device according to any one of (1) to (3), wherein
the other communication device is at least one of a set of communication candidates capable of performing the in-band full-duplex communication that is asynchronous, and
the control unit acquires timing information regarding timing of a frame boundary.
   (8)

The communication device according to (7), wherein the control unit acquires resource information regarding radio resource allocation used for the in-band full-duplex communication that is asynchronous.

(9)

The communication device according to (7) or (8), wherein the control unit acquires pair information regarding the set of the communication candidates.

(10)

The communication device according to any one of (7) to (9), wherein at least one of the control unit or the other communication device transmits a signal such that the signal can be decoded at the frame boundary.

(11)

The communication device according to (10), wherein at least one of the control unit or the other communication device sets a buffer interval at the timing of the frame boundary.

(12)

The communication device according to (11), wherein at least one of the control unit or the other communication device transmits a signal of a known sequence in the buffer interval.

(13)

The communication device according to any one of (1) to (12), wherein a signal transmitted and/or received by the control unit is an IBFD signal.

(14)

A communication method comprising:
determining whether or not a digital interference canceller is applicable to a reception signal received by in-band full-duplex communication;
determining whether or not to apply the digital interference canceller to the reception signal in a case where it is determined that the digital interference canceller is not applicable; and
in a case where it is determined to apply the digital interference canceller, determining to perform processing for applying the digital interference canceller with another communication device that performs the in-band full-duplex communication.
   (15)

A communication device comprising:
a control unit that performs processing with another communication device that performs in-band full-duplex communication in a case where the in-band full-duplex communication is performed, wherein
the control unit,
in a case where the other communication device has determined to apply a digital interference canceller to a reception signal in a case where the digital interference canceller is not applicable to the reception signal received by the in-band full-duplex communication, performs the processing for applying the digital interference canceller with the other communication device.
   (16)

A communication method comprising:
in a case where in-band full-duplex communication is performed, in a case where another communication device that performs the in-band full-duplex communication has determined to apply a digital interference canceller to a reception signal in a case where the digital interference canceller is not applicable to the reception signal received by the in-band full-duplex communication, performing processing for applying the digital interference canceller with the other communication device.

### REFERENCE SIGNS LIST

1 COMMUNICATION SYSTEM
10 MANAGEMENT DEVICE
11 COMMUNICATION UNIT
12, 22, 32, 42 STORAGE UNIT
13, 23, 33, 43 CONTROL UNIT
20 BASE STATION
21, 31, 41 WIRELESS COMMUNICATION UNIT
30 RELAY STATION
40 TERMINAL DEVICE

1. A communication device comprising:
a control unit that:
determines whether or not a digital interference canceller is applicable to a reception signal received by in-band full-duplex communication;
determines whether or not to apply the digital interference canceller to the reception signal in a case where it is determined that the digital interference canceller is not applicable; and
in a case where it is determined to apply the digital interference canceller, determines to perform processing for applying the digital interference canceller with another communication device that performs the in-band full-duplex communication.

2. The communication device according to claim 1, wherein
the reception signal is a signal received by the other communication device from a communication partner, and
the other communication device executes the processing with the communication partner in a case where the control unit determines to perform the processing.

3. The communication device according to claim 2, wherein the control unit determines whether or not to perform the processing on a basis of determination information acquired from the other communication device.

4. The communication device according to claim 1, wherein the control unit transmits, as the processing, a synchronization signal for establishing synchronization with the other communication device.

5. The communication device according to claim 4, wherein the synchronization signal includes at least one of information of a frame length or a slot length of the in-band full-duplex communication, information of a start point and/or an end point of a frame of the in-band full-duplex communication, information of a radio resource for performing the in-band full-duplex communication, or MCS information at a time of performing the in-band full-duplex communication.

6. The communication device according to claim 1, wherein the control unit requests the other communication device to transmit a signal for establishing synchronization in order to establish synchronization as the processing.

7. The communication device according to claim 1, wherein
the other communication device is at least one of a set of communication candidates capable of performing the in-band full-duplex communication that is asynchronous, and
the control unit acquires timing information regarding timing of a frame boundary.

8. The communication device according to claim 7, wherein the control unit acquires resource information regarding radio resource allocation used for the in-band full-duplex communication that is asynchronous.

9. The communication device according to claim 7, wherein the control unit acquires pair information regarding the set of the communication candidates.

10. The communication device according to claim 7, wherein at least one of the control unit or the other communication device transmits a signal such that the signal can be decoded at the frame boundary.

11. The communication device according to claim 10, wherein at least one of the control unit or the other communication device sets a buffer interval at the timing of the frame boundary.

12. The communication device according to claim 11, wherein at least one of the control unit or the other communication device transmits a signal of a known sequence in the buffer interval.

13. The communication device according to claim 1, wherein a signal transmitted and/or received by the control unit is an IBFD signal.

14. A communication method comprising:
determining whether or not a digital interference canceller is applicable to a reception signal received by in-band full-duplex communication;
determining whether or not to apply the digital interference canceller to the reception signal in a case where it is determined that the digital interference canceller is not applicable; and
in a case where it is determined to apply the digital interference canceller, determining to perform processing for applying the digital interference canceller with another communication device that performs the in-band full-duplex communication.

15. A communication device comprising:
a control unit that performs processing with another communication device that performs in-band full-duplex communication in a case where the in-band full-duplex communication is performed, wherein
the control unit,
in a case where the other communication device has determined to apply a digital interference canceller to a reception signal in a case where the digital interference canceller is not applicable to the reception signal received by the in-band full-duplex communication, performs the processing for applying the digital interference canceller with the other communication device.

16. A communication method comprising:
in a case where in-band full-duplex communication is performed, in a case where another communication device that performs the in-band full-duplex communication has determined to apply a digital interference canceller to a reception signal in a case where the digital interference canceller is not applicable to the reception signal received by the in-band full-duplex communication, performing processing for applying the digital interference canceller with the other communication device.
